(19) United States
(12) Patent Application Publication
(10) Pub. No.: US 2016/0371391 A1
(43) Pub. Date: Dec. 22, 2016

(54) CACHING SEARCH-RELATED DATA IN A SEMI-STRUCTURED DATABASE

(71) Applicant: QUALCOMM Incorporated, San Diego, CA (US)

(72) Inventors: Craig Matthew BROWN, New South Wales (AU); Michael William PADDON, Tokyo (JP); Xavier Claude FRANC, Sarthe (FR); Louis PAN, Lane Cove North (AU); Joel Timothy BEACH, Sydney (AU)

(21) Appl. No.: 14/864,495

(22) Filed: Sep. 24, 2015

Related U.S. Application Data
(60) Provisional application No. 62/180,994, filed on Jun. 17, 2015.

(51) Int. Cl. G06F 17/30

(52) U.S. Cl. CPC G06F 17/30908; G06F 17/30923

(57) ABSTRACT

In an embodiment, a server detects a threshold number of search queries for which the same value at a target node for a document in a semi-structured database is returned as a search result. The server caches the value based on the detection. In another embodiment, the server detects a threshold number of search queries that result in values being returned as search results from a target node. The server caches values at the target node based on the detection. In another embodiment, the server records search result heuristics that indicate a degree to which search results are expected from a set of search queries. The server obtains a merge query and establishes an order in which search queries in the merge query are to be executed based on the recorded search result heuristics.

### CROSS-REFERENCE TO RELATED APPLICATION

The present application for patent claims the benefit of U.S. Provisional Application No. 62/180,994, entitled “CACHING SEARCH-RELATED DATA IN A SEMI-STRUCTURED DATABASE”, filed Jun. 17, 2015, assigned to the assignee hereof, and expressly incorporated herein by reference in its entirety.

### BACKGROUND

1. Field

This disclosure relates to caching search-related data in a semi-structured database.

2. Description of the Related Art

Databases can store and index data in accordance with a structured data format (e.g., Relational Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with Name, Industry and Headquarters values, a new Bibliography data object may be required to be added with Author, Title, Journal and Date values, and so on). By contrast, in unstructured databases, new data objects can be added verbatim, so similar data objects can be added via different formats which may cause difficulties in establishing semantic relationships between the similar data objects.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a plurality of nodes arranged in a tree hierarchy. The document structure includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

### SUMMARY

An example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method may include detecting a threshold number of search queries for which a given value at a given target node for a given document of the set of documents is returned as a search result, and caching, in a value table stored in a cache memory, the given value in response to the detecting based on a document identifier for the given document and a path identifier that identifies a path between the root node and the given target node.

Another example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method may include detecting a threshold number of search queries that result in values being returned as search results from a given target node for a given document of the set of documents and caching, in a value table stored in a cache memory, values stored at the given target node in response to the detecting based on a document identifier for the given document of the given target node and a path identifier that identifies a path between the root node and the given target node for the given document.

Another example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method may include recording search result heuristics that indicate a degree to which search results are expected from each search query in a set of search queries, receiving a merge query that requests a merger of search results including two or more search queries from the set of search queries, establishing an order in which to perform the two or more search queries during execution of the merge query based on the recorded search result heuristics, executing at least one of the two or more search queries in accordance with the established order and returning one or more merged search results based on the executing.

Another example relates to a server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. In an example, the server may include logic configured to detect a threshold number of search queries for which a given value at a given target node for a given document of the set of documents is returned as a search result and logic configured to cache, in a value table stored in a cache memory, the given value in response to the detection based on a document identifier for the given document and a path identifier that identifies a path between the root node and the given target node.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipments (UEs) in accordance with embodiments of the disclosure.

FIG. 3 illustrates a communication device that includes logic configured to perform functionality in accordance with an embodiment of the disclosure.

FIG. 4 illustrates a server in accordance with an embodiment of the disclosure.

FIG. 5A illustrates an example of nodes in a tree hierarchy for a given document in accordance with an embodiment of the disclosure.

FIG. 5B illustrates an example of a context tree for the document depicted in FIG. 5A in accordance with an embodiment of the disclosure.

FIG. 5C illustrates another example of a context tree in accordance with another embodiment of the disclosure.

FIG. 6A illustrates a more detailed example of the tree hierarchy depicted in FIG. 5A in accordance with another embodiment of the disclosure.

FIG. 6B illustrates a flat element index for an XML database in accordance with an embodiment of the disclosure.

FIG. 6C illustrates a context tree for an XML database in accordance with an embodiment of the disclosure.

FIG. 7 illustrates a conventional process by which search queries are executed in a semi-structured database.

FIG. 8 illustrates a process of selectively caching node values in accordance with an embodiment of the disclosure.

FIG. 9 illustrates an example implementation of the process of FIG. 8 in accordance with an embodiment of the disclosure.

FIG. 10 illustrates a conventional process by which search queries are executed in a semi-structured database.

FIG. 11 illustrates a process of selectively caching node values in accordance with an embodiment of the disclosure.

FIG. 12 illustrates an example implementation of the process of FIG. 11 in accordance with an embodiment of the disclosure.

FIG. 13 illustrates a conventional merge query execution in a semi-structured database.

FIG. 14 illustrates a process of executing a merge query in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a wired access network and/or a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. In an embodiment, UEs can communicate with a core network via a RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to cellular telephones, personal digital assistants (PDAs), pagers, laptop computers, desktop computers, PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

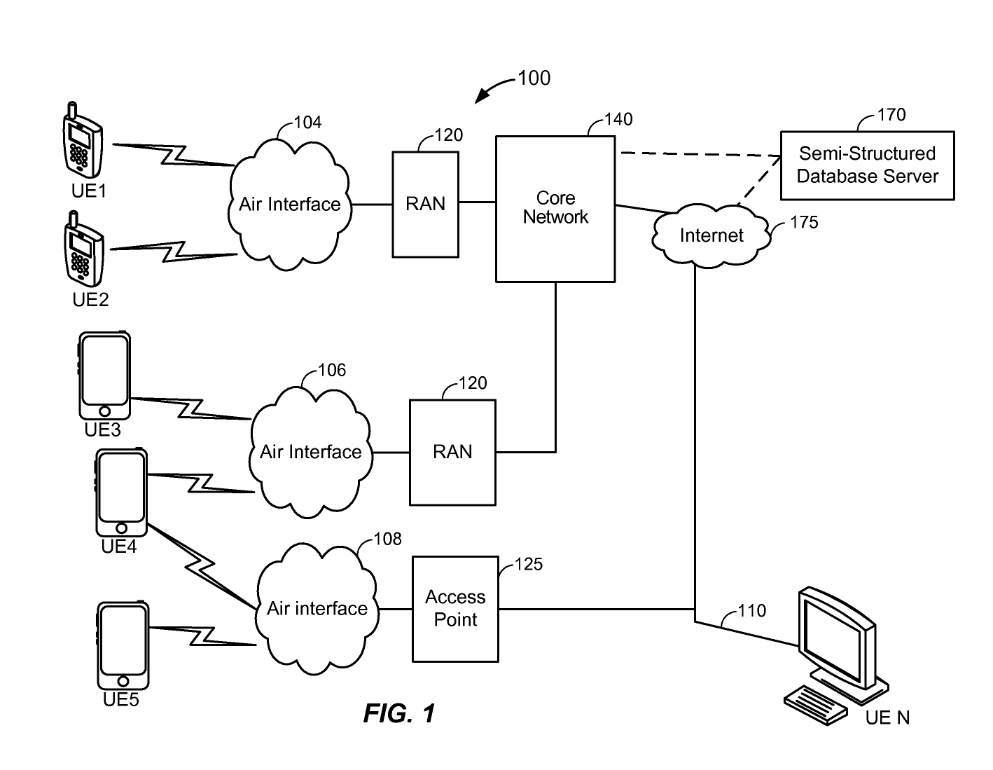

FIG. 1 illustrates a high-level system architecture of a wireless communications system 100 in accordance with an embodiment of the disclosure. The wireless communications system 100 contains UEs 1 . . . N. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., a RAN 120, an access point 125, etc.) over a physical communications interface or layer, shown in FIG. 1 as air interfaces 104, 106, 108 and/or a direct wired connection 110. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 may include a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 may be configured to connect to a core network 140 that can perform a variety of functions, including bridging circuit-switched (CS) calls between UEs served by the RAN 120 and other UEs served by the RAN 120 or a different RAN altogether, and may also mediate an exchange of packet-switched (PS) data with external networks such as Internet 175.

The Internet 175, in some examples, includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UEs 1 . . . N via the core network 140. Also shown in FIG. 1 is the access point 125 that is separate from the RAN 120. The access point 125 may be connected to the Internet 175 independent of the core network 140 (e.g., via an optical communications system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a semi-structured database server 170 is shown as connected to the Internet 175, the core network 140, or both. The semi-structured database server 170 can be implemented as a plurality of structurally separate servers (i.e., a distributed server arrangement), or alternately may correspond to a single server. The semi-structured database server 170 is responsible for maintaining a semi-structured database (e.g., an XML database, a JavaScript Object Notation (JSON) database, etc.) and executing search queries within the semi-structured database on behalf of one or more client devices, such as UEs 1 . . . N as depicted in FIG. 1. In some implementations, the semi-structured database server 170 can execute on one or more of the client devices as opposed to a network server, in which case the various client devices can interface with the semi-structured database server 170 via network connections as depicted in FIG. 1, or alternatively via local or peer-to-peer interfaces. In another example, the semi-structured database server 170 can run as an embedded part of an application on a device (e.g., a network server, a client device or UE, etc.). In this case, where the semi-structured database server 170 is implemented as an application that manages the semi-structured database, the application can operate without the need for inter-process communication between other applications on the device.

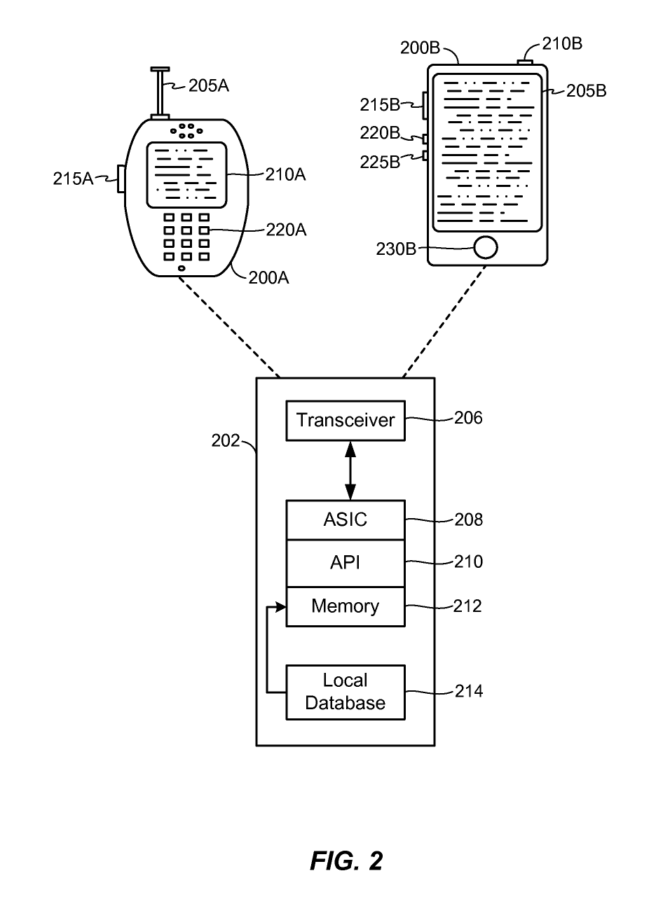

FIG. 2 illustrates examples of UEs (i.e., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of UE 200B, UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., the semi-structured database server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in a memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the disclosure can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the ASIC 208, the memory 212, the API 210 and the local database 214 may all be used cooperatively to load, store and execute the various functions disclosed herein and thus the logic to perform these functions may be distributed over various elements. Alternatively, the functionality could be incorporated into one discrete component. Therefore, the features of UEs 200A and 200B in FIG. 2 are to be considered merely illustrative and the disclosure is not limited to the illustrated features or arrangement.

The wireless communications between UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the disclosure and are merely to aid in the description of aspects of embodiments of the disclosure.

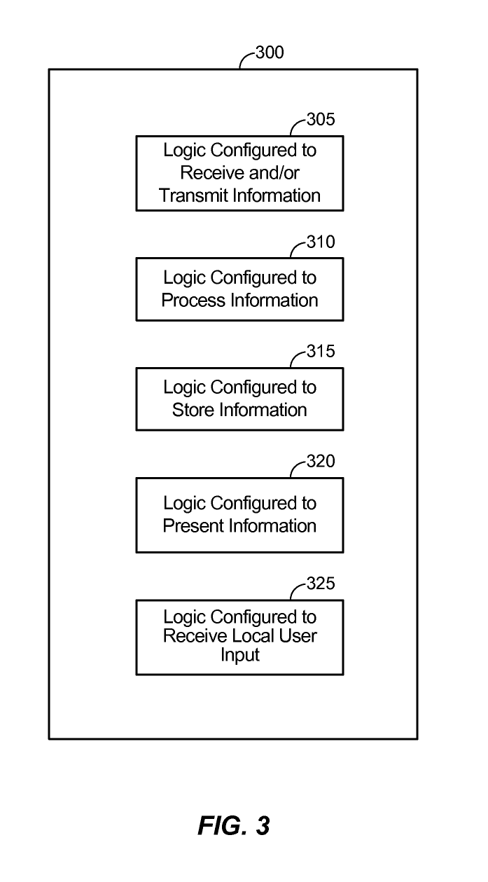

FIG. 3 illustrates a communications device 300 that includes logic configured to perform functionality in accordance with an embodiment of the disclosure. The communications device 300 can correspond to any of the above-noted communications devices, including but not limited to UEs 200A or 200B, any component of the RAN 120, any component of the core network 140, any components coupled with the core network 140 and/or the Internet 175 (e.g., the semi-structured database server 170), and so on. Thus, the communications device 300 can correspond to any electronic device that is configured to communicate with (or facilitate communication with) one or more other entities over the wireless communications system 100 of FIG. 1.

Referring to FIG. 3, the communications device 300 includes logic configured to receive and/or transmit information 305. In some embodiments such as when the communications device 300 corresponds to a wireless communications device (e.g., UE 200A or 200B, the access point 125, a BS, Node B or eNodeB in the RAN 120, etc.), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). For example, the communications device 300 may correspond to some type of network-based server (e.g., the semi-structured database server 170, etc.), and the logic configured to receive and/or transmit information 305 can correspond to an Ethernet card that connects the network-based server to other communication entities via an Ethernet protocol.

In a further example, the logic configured to receive and/or transmit information 305 can include sensory or measurement hardware by which the communications device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, in various implementations, the logic configured to receive and/or transmit information 305 does not correspond to software alone, and the logic configured to receive and/or transmit information 305 relies at least in part upon hardware to achieve its functionality.

The communications device 300 of FIG. 3 may further include logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communications device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, in various implementations, the logic configured to process information 310 does not correspond to software alone, and the logic configured to process information 310 relies at least in part upon hardware to achieve its functionality.

The communications device 300 of FIG. 3 may further include logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, in various implementations, the logic configured to store information 315 does not correspond to software alone, and the logic configured to store information 315 relies at least in part upon hardware to achieve its functionality.

The communications device 300 of FIG. 3 may further include logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 300. For example, if the communications device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communications devices, such as network communications devices that do not have a local user (e.g., network switches or routers, remote servers such as the semi-structured database server 170, etc.). The logic configured to present information 320 can also include software that, when executed, permits the associated hardware of the logic configured to present information 320 to perform its presentation function(s). However, in various implementations, the logic configured to present information 320 does not correspond to software alone, and the logic configured to present information 320 relies at least in part upon hardware to achieve its functionality.

The communications device 300 of FIG. 3 may further include logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 300. For example, if the communications device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communications devices, such as network communications devices that do not have a local user (e.g., network switches or routers, remote servers such as the semi-structured database server 170, etc.). The logic configured to receive local user input 325 can also include software that, when executed, permits the associated hardware of the logic configured to receive local user input 325 to perform its input reception function(s). However, in various implementations, the logic configured to receive local user input 325 does not correspond to software alone, and the logic configured to receive local user input 325 relies at least in part upon hardware to achieve its functionality.

Referring to FIG. 3, while the configured logics 305 through 325 are shown as separate or distinct blocks in FIG. 3, it will be appreciated that the hardware and/or software by which the respective configured logics 305 through 325 performs its functionality can overlap in part or as a whole. For example, any software used to facilitate the functionality of the configured logics 305 through 325 can be stored in the non-transitory memory associated with the logic configured to store information 315, such that the configured logics 305 through 325 each performs their functionality (i.e., in this case, software execution) based in part upon the operation of software stored by the logic configured to store information 315. Likewise, hardware that is directly associated with one of the configured logics 305 through 325 can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

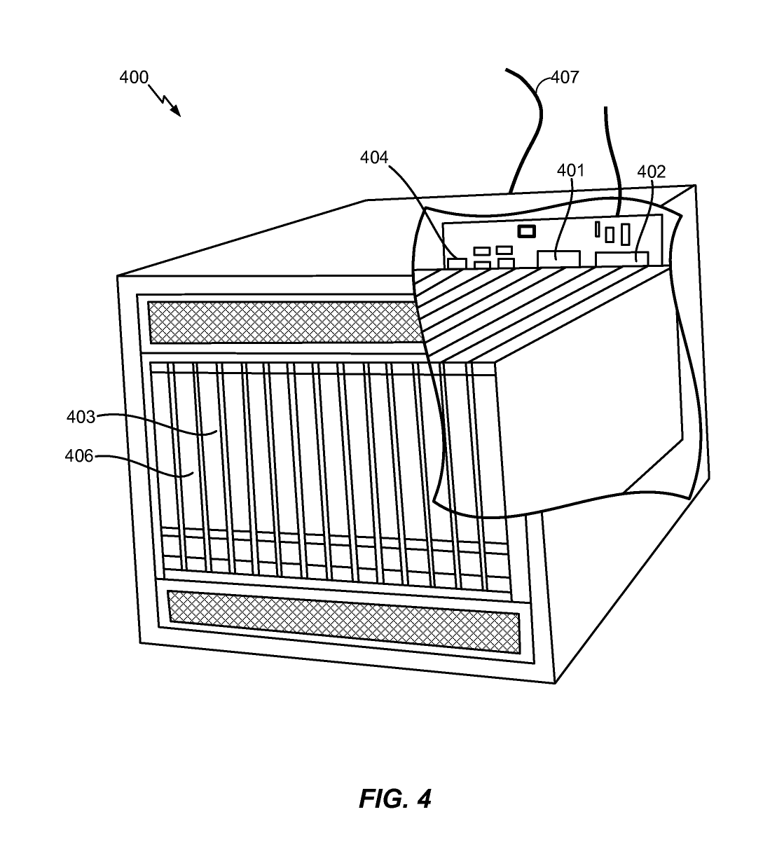

The various embodiments may be implemented on any of a variety of commercially available server devices, such as server 400 illustrated in FIG. 4. In an example, the server 400 may correspond to one example configuration of the semi-structured database server 170 described above. The server 400 may include a processor 401 coupled to a volatile memory 402 and a large capacity nonvolatile memory, such as a disk drive 403. The server 400 may also include a memory 406 (e.g., a floppy disc drive, compact disc (CD), a DVD disc drive, etc.) coupled to the processor 401. The server 400 may also include network access ports 404 coupled to the processor 401 for establishing data connections with a network via network connector 407, such as a local area network coupled to other broadcast system computers and servers or to the Internet. In context with FIG. 3, it will be appreciated that the server 400 of FIG. 4 illustrates one example implementation of the communications device 300, whereby the logic configured to transmit and/or receive information 305 corresponds to the network access ports 404 used by the server 400 to communicate via network connector 407, the logic configured to process information 310 corresponds to the processor 401, and the logic configured to store information 315 corresponds to any combination of the memory 406. The logic configured to present information 320 and the logic configured to receive local user input 325 are not shown explicitly in FIG. 4 and may or may not be included therein. Thus, FIG. 4 helps to demonstrate that the communications device 300 may be implemented as a server, in addition to a UE implementation as in FIG. 2.

Databases can store and index data in accordance with a structured data format (e.g., Relation Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with “Name”, “Industry” and “Headquarters” values, a new Bibliography data object may be required to be added with “Author”, “Title”, “Journal” and “Date” values, and so on). By contrast, in unstructured databases, new data objects are added verbatim, which permits similar data objects to be added via different formats which causes difficulties in establishing semantic relationships between the similar data objects.

Examples of structured database entries for a set of data objects may be configured as follows:

TABLE 1
Example of Structured Database Entry for a Company Data Object

| Name | Industry | Headquarters |
|---|---|---|
| Company X | Semiconductor; | San Diego, California, USA |
| | Wireless Telecommunications | |

whereby “Name”, “Industry” and “Headquarters” are predetermined values that are associated with each “Company”-type data object stored in the structured database, or

TABLE 2
Example of Structured Database Entry
for Bibliography Data Objects

| Author | Title | Journal | Date |
|---|---|---|---|
| Cox, J. | Company X races to retool | Network World | 2007 |
| | the mobile phone | | |
| Arensman, | Meet the New Company X | Electronic Business | 2000 |
| Russ | | | |

whereby “Author”, “Title”, “Journal” and “Date” are predetermined values that are associated with each “Bibliography”-type data object stored in the structured database.

Examples of unstructured database entries for the set of data objects may be configured as follows:

TABLE 3
Example of Unstructured Database
Entry for a Company Data Object

Company X is an American global semiconductor company that designs
and markets wireless telecommunications products and services. The
company headquarters are located in San Diego, California, USA.

TABLE 4
Example of Unstructured Database Entry
for Bibliography Data Objects

Cox, J. (2007). ‘Company X races to retool the mobile phone’. Network
World, 24/8: 26.
Arensman, Russ. “Meet the New Company X.” Electronic Business, Mar.
1, 2000.

As will be appreciated, the structured and unstructured databases in Tables 1 and 3 and in Tables 2 and 4 store substantially the same information, with the structured database having a rigidly defined value format for the respective class of data object while the unstructured database does not have defined values associated for data object classes.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a set of one or more documents that each have a plurality of nodes arranged in a tree hierarchy. The plurality of nodes are generally implemented as logical nodes (e.g., the plurality of nodes can reside in a single memory and/or physical device), although it is possible that some of the nodes are deployed on different physical devices (e.g., in a distributed server environment) so as to qualify as both distinct logical and physical nodes. Each document includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

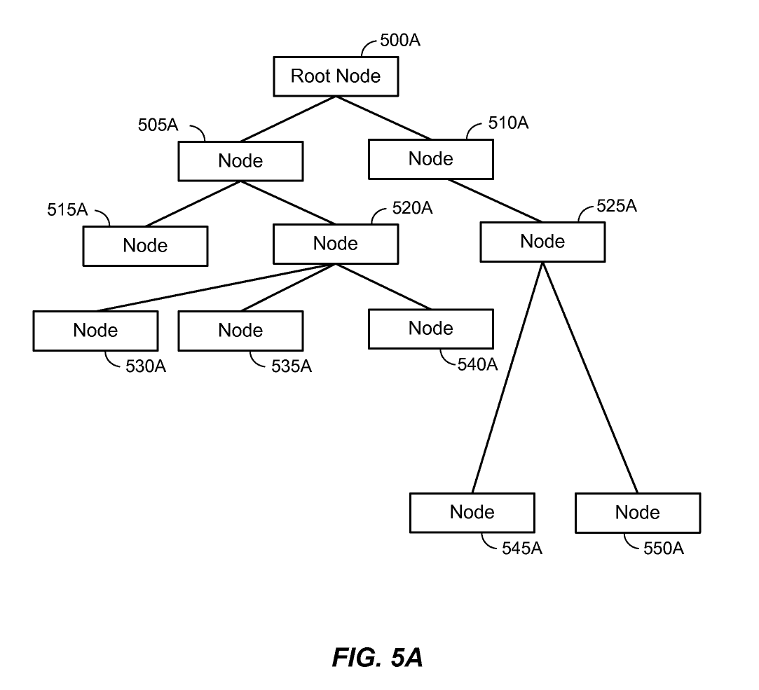

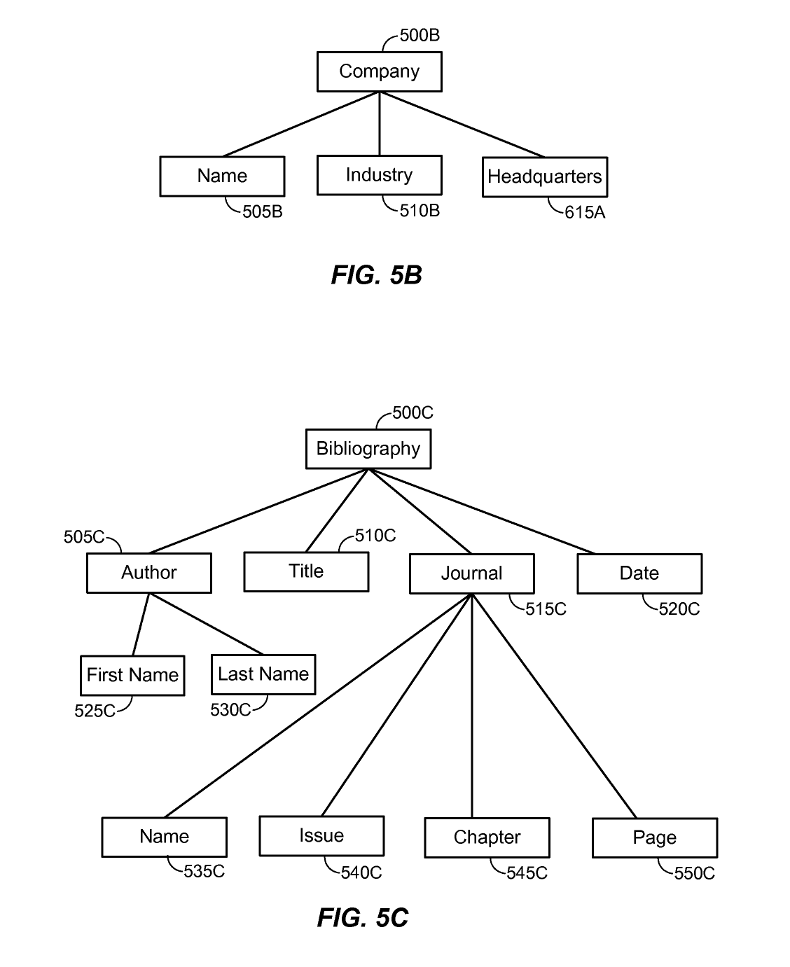

FIG. 5A illustrates a set of nodes in a tree hierarchy for a given document in accordance with an embodiment of the disclosure. As illustrated, a root node 500A contains descendant nodes 505A and 510A, which in turn contain descendant nodes 515A, 520A and 525A, respectively, which in turn contain descendant nodes 530A, 535A, 540A, 545A and 550A, respectively.

FIGS. 5B-5C illustrate examples of context trees for example documents in accordance with various embodiments of the disclosure. With respect to at least FIGS. 5B-5C, references to context paths and context trees are made below, with these terms being defined as follows:
Context Path: One node in a context tree.
Context Tree: The complete set of all paths in a set of documents.

FIG. 5B illustrates an example of the context tree for a “Company” document based on the data from Tables 1 and 3 (above). Referring to FIG. 5B, there is a root context path “Company” 500B, and three descendant context paths 505B, 510B, 515B for “Name”, “Industry” and “Headquarters” values, respectively. For a JSON-based semi-structured database, the data object depicted above in Tables 1 and 3 may be recorded as follows:

TABLE 5
Example of JSON-based Semi-Structured Database Entry for a Company
Data Object

```
{
  “Company”: “Company X”,
  “Industry”: [
        “Semiconductor”,
        “Wireless telecommunications” ],
  “Headquarters” :
        “San Diego, California, USA”
}
```

FIG. 5C illustrates an example of the context tree for a “Bibliography” document based on the data from Tables 2 and 4 (above). Referring to FIG. 5C, there is a root context path “Bibliography” 500C, which has four descendant context paths 505C, 510C, 515C and 520C for “Author”, “Title”, “Journal” and “Date”, respectively. The Author context path 505C further has two additional descendant context paths 525C and 530C for “First Name” and “Last Name”, respectively. Further, the context path “Journal” 515C has four descendant context paths 535C, 540C, 545C and 550C for “Name”, “Issue”, “Chapter” and “Page”, respectively. For an XML-based semi-structured database, the data object depicted above in Tables 2 and 4 that is authored by J. Cox may be recorded as follows:

TABLE 6
Example of XML-based Semi-Structured
Database Entry for a Bibliography Data Object

```
<Bibliography>
    <Author>
        <LastName>Cox</LastName>
        <FirstName>J.</FirstName>
    </Author>
    <Title>Company X races ...</Title>
    <Journal>
        <Name>Network World</Name>
        <Issue>24</Issue>
        <Chapter>8</Chapter>
        <Page>26</Page>
    </Journal>
    <Date>2007</Date>
</Bibliography>
```

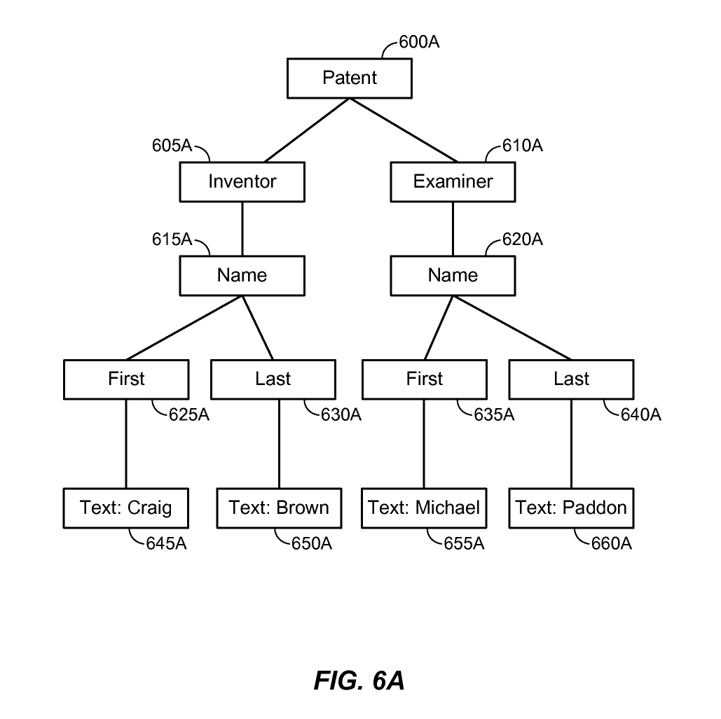

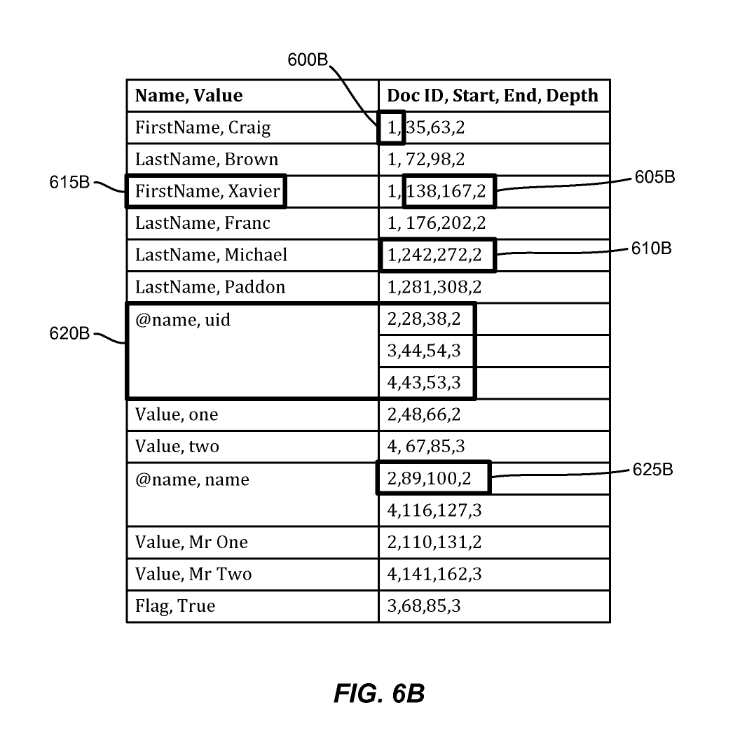

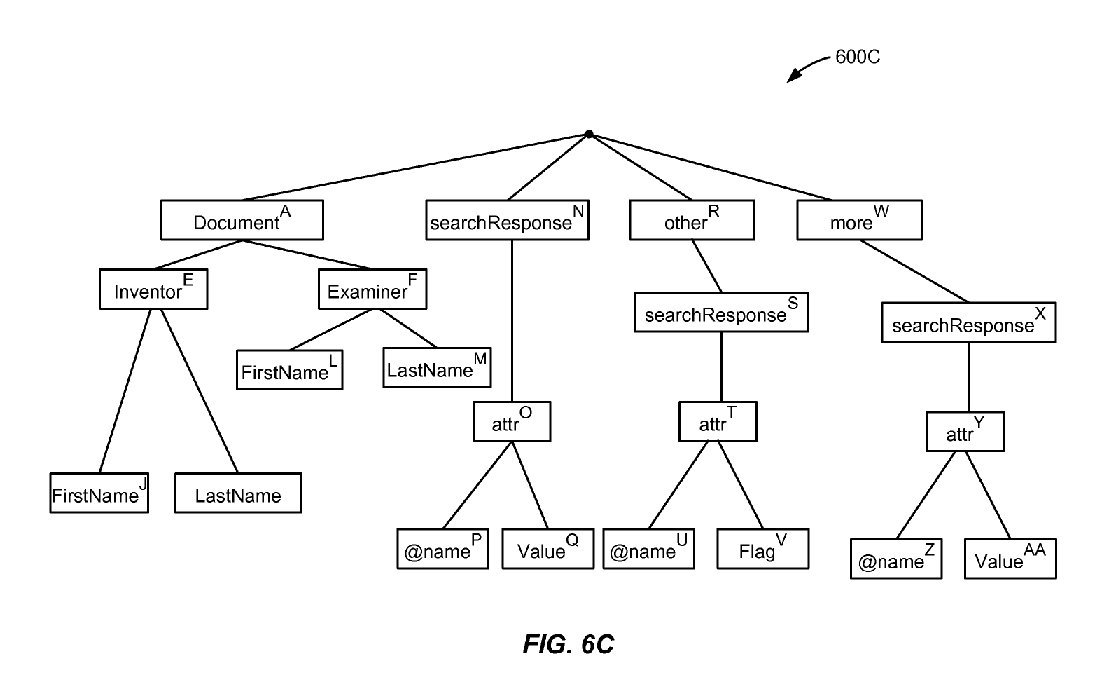

FIG. 6A illustrates an example context tree for a “Patent” document in accordance with an embodiment of the disclosure. In FIG. 6A, the document is a patent information database with a root node “Patent” 600A, which has two descendant nodes 605A and 610A for “Inventor” and “Examiner”, respectively. Each has a descendant node entitled “Name”, 615A and 620A, which in turn each have descendant nodes entitled “First” and “Last”, 625A, 630A, 635A and 640A. Further depicted in FIG. 6A are textual data objects that are stored in the respective nodes 625A-640A. In particular, for an Examiner named “Michael Paddon” and an inventor named “Craig Brown” for a particular patent document, the text “Craig” 645A is stored in a node represented by the context path /Patent/Inventor/Name/First, the text “Brown” 650A is stored in a node represented by the context path /Patent/Inventor/Name/Last, the text “Michael” 655A is stored in a node represented by the context path /Patent/Examiner/Name/First and the text “Paddon” 660A is stored in a node represented by the context path /Patent/Examiner/Name/Last. As will be discussed below in more detail, each context path can be associated with its own index entry in a Context Path Element Index, and each unique value at a particular context path can also have its own index entry in a Context Path Simple Content Index.

To put the document depicted in FIG. 6A into context with respect to XPath queries in an example where the semi-structured database corresponds to an XML database, an XPath query directed to /Patent/Inventor/Name/Last will return each data object at this context path within the tree hierarchy, in this case, “Brown”. In another scenario, the XPath query can implicate multiple nodes. For example, an XPath query directed to //Name/Last maps to both the context path /Patent/Inventor/Name/Last and the context path /Patent/Examiner/Name/Last, so this query would return each data object at any qualifying location of the tree hierarchy, in this case, both “Brown” and “Paddon”.

The document structure of a particular document in a semi-structured database can be indexed in accordance with a flat-indexing protocol or a label-path protocol. For example, in the flat-indexing protocol (sometimes referred to as a “node indexing” protocol) for an XML database, each node is indexed with a document identifier at which the node is located, a start-point and an end-point that identifies the range of the node, and a depth that indicates the node's depth in the tree hierarchy of the document (e.g., in FIG. 6A, the root node “Patent” 600A (or root context path) has depth=0, the “Inventor” and “Examiner” context paths 605A and 610A have depth=1, and so on). The range of any parent node envelops or overlaps with the range(s) of each of the parent node's respective descendant nodes. Accordingly, assuming that the document identifier is 40, the root node “Patent” 600A document depicted in FIG. 6A can be indexed as follows:

TABLE 7
Example of XML-based Tree Hierarchy Shown in FIG. 6A

```
<Patent> ¹
    <Inventor> ²
        <Name> ³
            <First> ⁴Craig</First> ⁵
            <Last> ⁶Brown</Last> ⁷
        </Name> ⁸
    </Inventor> ⁹
    <Examiner> ¹⁰
        <Name> ¹¹
            <First> ¹²Michael</First> ¹³
            <Last> ¹⁴Paddon</Last> ¹⁵
        </Name> ¹⁶
    </Examiner> ¹⁷
</Patent> ¹⁸
```

whereby each number represents a location of the document structure that can be used to define the respective node range, as shown in Table 8 as follows:

TABLE 8
Example of Flat-Indexing of Nodes of FIG. 6A Based on Table 7

| Name, Value | Docid, Start, End, Depth |
|---|---|
| Inventor | (40, 2, 9, 1) |
| Name | (40, 3, 8, 2), |
| | (40, 11, 16, 2) |
| Last, Brown | (40, 6, 7, 3) |
| Last, Paddon | (40, 14, 15, 3) |

Accordingly, the “Inventor” context path 605A of FIG. 6A is part of document 40, starts at location 2 and ends at location 9 as shown in Table 7, and has a depth of 1 in the tree hierarchy depicted in FIG. 6A, such that the “Inventor” context path 605A is indexed as (40,2,9,1) in Table 8. The “Name” context paths 615A and 620A of FIG. 6A are part of document 40, start at locations 3 and 11, respectively, and end at locations 8 and 16, respectively, as shown in Table 7, and have a depth of 2 in the tree hierarchy depicted in FIG. 6A, such that the “Name” context paths 615A and 620A are indexed as (40,3,8,2) and (40,11,16,2) in Table 8.

When a node stores a value, the value itself can have its own index. Accordingly, the value of “Brown” 650A as shown in FIG. 6A is part of document 40, start at location 6 and ends at location 7 as shown in Table 7, and has a depth of 3 (i.e., the depth of the node that stores the associated value of “Brown”) in the tree hierarchy depicted in FIG. 6A, such that the “Brown” value 650A is indexed as (40,6,7,3) in Table 8. The value of “Paddon” 660A as shown in FIG. 6A is part of document 40, start at location 14 and ends at location 15 as shown in Table 7, and has a depth of 3 (i.e., the depth of the node that stores the associated value of “Paddon”) in the tree hierarchy depicted in FIG. 6A, such that the “Paddon” value 660A is indexed as (40,14,15,3) in Table 8.

The flat-indexing protocol uses a brute-force approach to resolve paths. In an XML-specific example, an XPath query for /Patent/Inventor/Name/Last would require separate searches to each node in the address (i.e., “Patent”, “Inventor”, “Name” and “Last”), with the results of each query being joined with the results of each other query, as follows:

TABLE 9
Example of XPath Query for a Flat-Indexed Database

```
joinChild(
    joinChild(
        joinChild(
            lookup(Patent),
            lookup(Inventor)),
        lookup(Name)),
    lookup(Last))
```

Label-path indexing is described in a publication by Goldman et al. entitled “DataGuides: Enabling Query Formulation and Optimization in Semistructured Databases”. Generally, label-path indexing is an alternative to flat-indexing, whereby the path to the target node is indexed in place of the node identifier of the flat-indexing protocol, as follows:

TABLE 10
Example of XML-based Tree Hierarchy Shown in FIG. 6A

```
<Patent>_{A}¹
    <Inventor>_{B}²
        <Name>_{C}³
            <First>_{D}⁴Craig</First>⁵
            <Last>_{E}⁶Brown</Last>⁷
        </Name>⁸
    </Inventor>⁹
    <Examiner>_{F}¹⁰
        <Name>_{G}¹¹
            <First>_{H}¹²Michael</First>¹³
            <Last>_{I}¹⁴Paddon</Last>¹⁵
        </Name>¹⁶
    </Examiner>¹⁷
</Patent>¹⁸
```

whereby each number represents a location of the document structure that can be used to defined the respective node range, and each letter label (A through I) identifies a context path to a particular node or value, as shown in Table 11 as follows:

TABLE 11
Example of Label-Path Indexing of
Nodes of FIG. 6A Based on Table 10

| Context Path, Node or Value | Docid, Start, End, Depth |
|---|---|
| B (/Patent/Inventor) | (40, 2, 9, 1) |
| C (/Patent/Inventor/Name) | (40, 3, 8, 2) |
| E (/Patent/Inventor/Name/Last), Brown | (40, 6, 7, 3) |
| H(/Patent/Examiner/Name/First), Michael | (40, 12, 13, 3) |

Accordingly, with respect to Tables 10-11, the “Inventor” node 605A of FIG. 6A at the context path /Patent/Inventor (or context path B) is part of document 40, starts at location 2 and ends at location 9 as shown in Table 10, and has a depth of 1 in the tree hierarchy depicted in FIG. 6A, such that the “Inventor” context path 605A is indexed as (40,2,9,1) in Table 11. The “Name” context path 615A of FIG. 6A at the context path /Patent/Inventor/Name (or context path C) is part of document 40, starts at location 3 and ends at location 8 as shown in Table 10, and has a depth of 2 in the tree hierarchy depicted in FIG. 6A, such that the “Name” context path 615A is indexed as (40,3,8,2) in Table 11. The “Brown” value 650A of FIG. 6A at the context path /Patent/Inventor/Name/Last (or context path E) is part of document 40, starts at location 6 and ends at location 7 as shown in Table 10, and has a depth of 3 (i.e., the depth of the node that stores the “Brown” value 650A) in the tree hierarchy depicted in FIG. 6A, such that the “Brown” value 650A is indexed as (40,6,7,3) in Table 11. The “Michael” value 655A of FIG. 6A at the context path /Patent/Examiner/Name/First (or context path H) is part of document 40, starts at location 12 and ends at location 13 as shown in Table 10, and has a depth of 3 (i.e., the depth of the node that stores the “Michael” value 655A) in the tree hierarchy depicted in FIG. 6A, such that the “Michael” value 655A is indexed as (40,12,13,3) in Table 11.

More detailed XML descriptions will now be provided. At the outset, certain XML terminology is defined as follows:
Byte Offset: Byte count from the start of a file. In certain embodiments of this disclosure, it is assumed that one character is equal to one byte, but it will be appreciated by one of ordinary skill in the art this is simply for convenience of explanation and that multi-byte characters such as those used in foreign languages could also be handled in other embodiments of this disclosure.
Context ID: A unique ID for a context path. In certain embodiments of this disclosure, the Context ID is indicated via a single capital letter.
Node ID: Start byte offset, end byte offset, and depth uniquely identifying a node within a document.
Document ID/Doc ID: Identifier uniquely identifying an XML document index.
Context Path Element Index: Index where the index key contains a Context ID. Used for elements that contain both simple and complex content, where simple content means the element contains text only and complex content means elements contain other elements or a mixture or text and elements. The index value contains a Doc ID/Node ID pair.
Context Path Simple Content Index: Index where the index key contains a Context ID and a value. The index value contains a Doc ID/Node ID pair.
Flat Element Index: Index where the index key contains a node name. Used for elements that contain both simple and complex content. The index value contains a Doc ID/Node ID pair.
Flat Simple Context Index: Index where the index key contains a node name and a value. The index value contains a Doc ID/Node ID pair.
Path Instance: The route from the top of a document down to a specific node within the document.
Posting: Doc ID/Node ID tuple uniquely identifying a node within a database.
XML Document: A single well-formed XML document.

In Table 9 with respect to the flat-indexed protocol, it will be appreciated that the XPath query directed to /Patent/Inventor/Name/Last required four separate lookups for each of the nodes “Patent”, “Inventor”, “Name” and “Last”, along with three joins on the respective lookup results. By contrast, a similar XPath query directed to /Patent/Inventor/Name/Last using the label-path indexing depicted in Tables 10-11 would have a compiled query of lookup(E) based on the path /Patent/Inventor/Name/Last being defined as path “E”.

Generally, the label-path indexing protocol is more efficient for databases with a relatively low number of context paths for a given node name (e.g., less than a threshold such as 100), with the flat-indexing protocol overtaking the label-path indexing protocol in terms of query execution time as the number of context paths increases.

A number of different example XML document structures are depicted below in Table 12 including start and end byte offsets:

TABLE 12
XML Document Examples with Start and End Byte Offsets

```
Document 1
<Document>_{A}⁰
  <Inventor>_{E}¹⁶
    <FirstName>_{J}³⁵Craig</FirstName>⁶³
    <LastName>_{K}⁷²Brown</LastName>⁹⁸
  </Inventor>¹¹⁴
  <Inventor>_{E}¹¹⁹
    <FirstName>_{J}¹³⁸Xavier</FirstName>¹⁶⁷
    <LastName>_{K}¹⁷⁶Franc</LastName>²⁰²
  </Inventor>²¹⁸
  <Examiner>_{F}²²³
    <FirstName>_{L}²⁴²Michael</FirstName>²⁷²
    <LastName>_{M}²⁸¹Paddon</LastName>³⁰⁸
  </Examiner>³²⁴
</Document>³³⁶
Document 2
<searchResponse>_{N}⁰
  <attr ²⁸name_{P} =”uid”³⁸> _{O}²²
    <Value>_{Q}⁴⁸one</Value>⁶⁶
  </attr>⁷⁸
  <attr⁸⁹name_{P}=”name”¹⁰⁰>_{O}¹¹⁰
    <Value>_{Q}¹¹⁰Mr One</Value>¹³¹
  </attr>¹⁴³
</searchResponse>¹⁶¹
Document 3
<other>_{R}⁰
  <searchResponse>_{S}¹³
    <attr⁴⁴name_{U}=”uid”⁵⁴>_{T}³⁸
      <Flag>_{V}⁶⁸True</Flag>⁸⁵
    </attr>¹⁰¹
  </searchResponse>¹²³
</other>¹³²
Document 4
<more>_{W}⁰
  <searchResponse>_{X}¹²
    <attr ⁴³name_{Z}=”uid” ⁵³>_{Y}³⁷
      <Value>_{AA}⁶⁷two</Value>⁸⁵
    </attr>¹⁰¹
    <attr¹¹⁶name_{Z}=”name” ¹²⁷>_{Y}¹¹⁰
      <Value>_{AA}¹⁴¹Mr Two</Value>¹⁶²
    </attr>¹⁷⁸
  </searchResponse>²⁰⁰
</more>²⁰⁸
```

whereby each number represents a location of the document structure that can be used to defined the respective node range, and each letter label identifies a context path to a particular node or value as depicted in FIG. 6C (described below in more detail).

Next, a flat simple content index for the documents depicted in Table 12 is as follows:

TABLE 13
Flat Simple Content Index

| Name, Value | Doc ID, Start, End, Depth |
|---|---|
| FirstName, Craig | 1, 35, 63, 2 |
| LastName, Brown | 1, 72, 98, 2 |
| FirstName, Xavier | 1, 138, 167, 2 |
| LastName, Franc | 1, 176, 202, 2 |
| FirstName, Michael | 1, 242, 272, 2 |
| LastName, Paddon | 1, 281, 308, 2 |
| @name, uid | 2, 28, 38, 2 |
| | 3, 44, 54, 3 |
| | 4, 43, 53, 3 |
| Value, one | 2, 48, 66, 2 |
| Value, two | 4, 67, 85, 3 |
| @name, name | 2, 89, 100, 2 |
| | 4, 116, 127, 3 |
| Value, Mr One | 2, 110, 131, 2 |
| Value, Mr Two | 4, 141, 162, 3 |
| Flag, True | 3, 68, 85, 3 |

Next, a flat element index for the documents depicted in Table 12 is as follows,

TABLE 14
Flat Element Index

| Name | Doc ID, Start, End, Depth |
|---|---|
| document | 1, 0, 336, 0 |
| Inventor | 1, 16, 114, 1 |
| | 1, 119, 218, 1 |
| FirstName | 1, 35, 63, 2 |
| | 1, 138, 167, 2 |
| | 1, 242, 272, 2 |
| LastName | 1, 72, 98, 2 |
| | 1, 176, 202, 2 |
| | 1, 281, 308, 2 |
| Examiner | 1, 223, 324, 1 |
| searchResponse | 2, 0, 161, 0 |
| | 3, 13, 123, 1 |
| | 4, 12, 200, 1 |
| other | 3, 0, 132, 0 |
| more | 4, 0, 208, 0 |
| @name | 2, 28, 38, 2 |
| | 3, 44, 54, 3 |
| | 4, 43, 53, 3 |
| | 2, 89, 100, 2 |
| | 4, 116, 127, 3 |
| Value | 2, 48, 66, 2 |
| | 2, 110, 131, 2 |
| | 4, 67, 85, 3 |
| | 4, 141, 162, 3 |
| Flag | 3, 68, 85, 3 |

FIG. 6B illustrates an annotated version of Table 13, including examples of a document identifier 600B (e.g., “1” for document 1 of Table 12), a node identifier 605B (e.g., 138,167,2, to denote the start byte, end byte and depth of a particular node, respectively), an index value 610B (e.g., a combination of document identifier, and index value), an index key 615B (e.g., “FirstName:Xavier”), an index entry 620B (e.g., a combination of index key and each associated index value) and a posting 625B (e.g., one of a plurality of document identifier and node identifier combinations for a particular index entry).

FIG. 6C illustrates a context tree 600C with labeled context paths based on the documents depicted above in Table 12, and further based on the context tree simple content index depicted below in Table 15 and the context tree element index depicted below in Table 16:

TABLE 15
Context Tree Simple Content Index

| Context ID, Value | Doc ID, Start, End, Depth |
|---|---|
| J, Craig | 1, 35, 63, 2 |
| K, Brown | 1, 72, 98, 2 |
| J, Xavier | 1, 138, 167, 2 |
| K, Franc | 1, 176, 202, 2 |
| L, Michael | 1, 242, 272, 2 |
| M, Paddon | 1, 281, 308, 2 |
| P, uid | 2, 28, 38, 2 |
| U, uid | 3, 44, 54, 3 |
| Z, uid | 4, 43, 53, 3 |
| Q, one | 2, 48, 66, 2 |
| AA, two | 4, 67, 85, 3 |
| P, name | 2, 89, 100, 2 |
| Z, name | 4, 116, 127, 3 |
| Q, Mr One | 2, 110, 131, 2 |
| AA, Mr Two | 4, 141, 162, 3 |
| V, True | 3, 68, 85, 3 |

TABLE 16
Context Tree Element Index

| Name | Doc ID, Start, End, Depth |
|---|---|
| A | 1, 0, 336, 0 |
| E | 1, 16, 114, 1 |
| | 1, 119, 218, 1 |
| J | 1, 35, 63, 2 |
| | 1, 138, 167, 2 |
| L | 1, 242, 272, 2 |
| K | 1, 72, 98, 2 |
| | 1, 176, 202, 2 |
| M | 1, 281, 308, 2 |
| F | 1, 223, 324, 1 |
| N | 2, 0, 161, 0 |
| S | 3, 13, 123, 1 |
| X | 4, 12, 200, 1 |
| R | 3, 0, 132, 0 |
| W | 4, 0, 208, 0 |
| P | 2, 28, 38, 2 |
| | 2, 89, 100, 2 |
| U | 3, 44, 54, 3 |
| Z | 4, 43, 53, 3 |
| | 4, 116, 127, 3 |
| O | 2, 48, 66, 2 |
| | 2, 110, 131, 2 |
| AA | 4, 67, 85, 3 |
| | 4, 141, 162, 3 |
| V | 3, 68, 85, 3 |

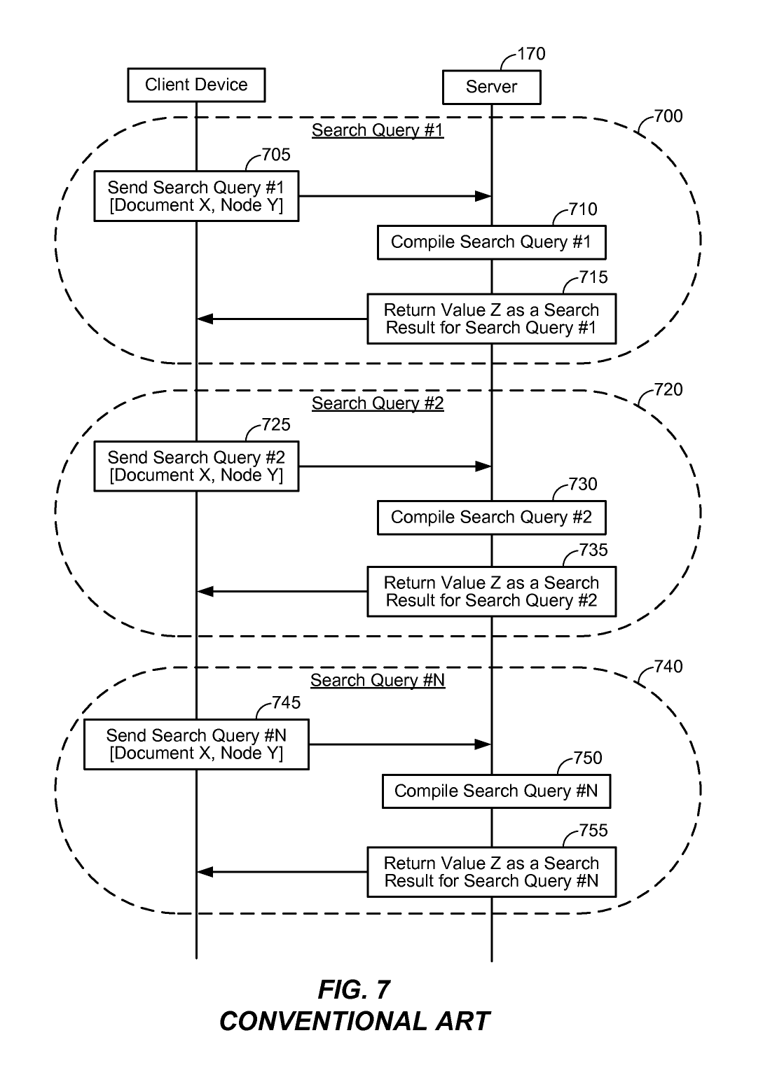

The nodes of semi-structured databases can include various types of data with various associated elements and attributes. Some nodes in particular only contain a relatively small amount of data (or a single value), such as a string, a date, a number, a reference to another node and/or document location in the semi-structured database, and so on. These nodes are referred to herein as “simple” nodes. As shown in FIG. 7, repeated search queries to simple nodes results in the same value being returned to requesting client devices over and over.

FIG. 7 illustrates a conventional process by which search queries are executed in a semi-structured database. Referring to FIG. 7, block sequence 700 depicts execution of a first search query, whereby a given client device sends the first search query to the semi-structured database server 170, in block 705, the semi-structured database server 170 compiles each search parameter in the first search query to obtain search results, in block 710, and the semi-structured database server 170 then returns any search results for the first search query back to the given client device, in block 715. In an example, compiling the search query at block 710 can include a number of operations, such as joining search results returned for different search parameters. With respect to FIG. 7, the first search query is directed at least in part to a lookup of Node Y of Document X, with Value Z being returned as a result of this lookup. It will be appreciated that, in an alternative scenario, the lookup of Node Y of Document X may be performed as an intermediate query (e.g., a reference, etc.) that does not result in Value Z being returned directly to the given client device.

Referring to FIG. 7, block sequence 720 depicts execution of a second search query, whereby the same or different client device sends the second search query to the semi-structured database server 170, in block 725, the semi-structured database server 170 compiles each search parameter in the second search query to obtain search results, in block 730, and the semi-structured database server 170 then returns any search results for the second search query back to the requesting client device, in block 735. In an example, compiling the search query at block 730 can include a number of operations, such as joining search results returned for different search parameters. With respect to FIG. 7, the second search query is also directed at least in part to a lookup of Node Y of Document X, with Value Z being returned as a result of this lookup, similar to block 715. It will be appreciated that, in an alternative scenario, the lookup of Node Y of Document X may be performed as an intermediate query (e.g., a reference, etc.) that does not result in Value Z being returned directly to the requesting client device.

Referring to FIG. 7, block sequence 740 depicts execution of an Nth search query, whereby the same or different client device sends the Nth search query to the semi-structured database server 170, in block 745, the semi-structured database server 170 compiles each search parameter in the Nth search query to obtain search results, in block 750, and the semi-structured database server 170 then returns any search results for the Nth search query back to the requesting client device, in block 755. In an example, compiling the search query at block 750 can include a number of operations, such as joining search results returned for different search parameters. With respect to FIG. 7, the Nth search query is also directed at least in part to a lookup of Node Y of Document X, with Value Z being returned as a result of this lookup, similar to blocks 715 and 735. It will be appreciated that, in an alternative scenario, the lookup of Node Y of Document X may be performed as an intermediate query (e.g., a reference, etc.) that does not result in Value Z being returned directly to the requesting client device.

As will be appreciated from a review of FIG. 7, while some nodes in the semi-structured database may include a variety of different data types, other nodes (e.g., simple nodes) will reliably return the same value again and again. Embodiments of the disclosure are related in part to selectively caching values associated with nodes (e.g., simple nodes) that are predicted to reliably return the same value.

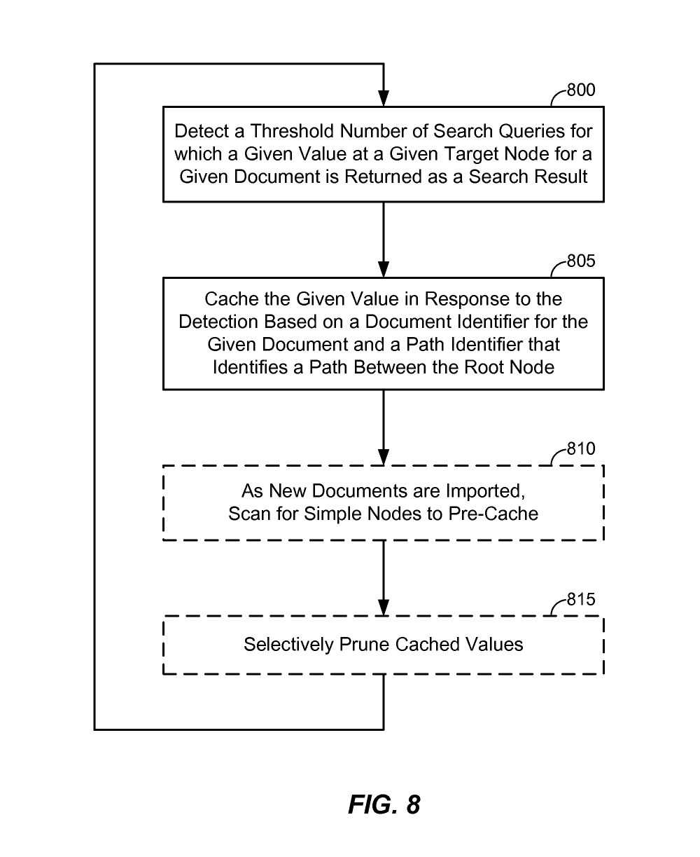

FIG. 8 illustrates a process of selectively caching node values in accordance with an embodiment of the disclosure. Referring to FIG. 8, the semi-structured database server 170 detects a threshold number of search queries for which a given value at a given target node of a given document is returned as a search result, in block 800. The threshold number can be set by an operator of the semi-structured database based on empirical study in an example. For example, the threshold number can be established when a target confidence level is reached that the target node is a “simple” node that only includes one particular value. In a more detailed example, the target confidence level may be 95%, and 5 consecutive search queries to a node that return the same value may imply a 97% probability that the node only includes that one value, which results in the threshold number used in block 800 being set to 5.

Further, with respect to block 800 of FIG. 8, evaluation of the threshold may be based on a node-specific value counter that is maintained by the semi-structured database server 170. Node-specific value counters can be maintained for each node at each document in the semi-structured database, or alternatively can only be maintained for certain nodes in a more selective manner. In a further example, the detection in block 800 can be based more specifically upon the number of consecutive search queries to a particular node that return the same value. In a further example, the node-specific value counter can be incremented each time a new search query is detected for a particular node that returns the same value as a previous search query for that particular node, and the node-specific value counter can be decremented (or even reset) when the new search query for a particular node returns a different value than a previous search query for that particular node. In yet another example, detection of a node returning different values in response to different search queries may trigger the semi-structured database server 170 to stop maintaining the node-specific value counter for this node, as it can reasonably be concluded that such a node is not a simple node (i.e., a node with a single value). In a further example, an additional condition for the detection in block 800 is that the threshold number of search queries must occur within a given period of time, such that older search queries are not counted in the node-specific value counter (e.g., the node-specific value counter can be decremented each time a search query expires in this manner). To this end, each node-specific value counter may have a half-life whereby the node-specific value counter is decremented at a given time interval, so new search queries directed to the associated node are required for incrementing the node-specific value counter in order to maintain the cached value for the associated node in a cache memory of the semi-structured database server 170.

Referring to FIG. 8, in response to the detection in block 800, the semi-structured database server 170 caches, in a value table stored in a cache memory (e.g., RAM, the volatile memory 402 and the disk drive 403 of FIG. 4, logic configured to store information 315 of FIG. 3, etc.) of the semi-structured database server 170, the given value based on a document identifier for the given document and a path identifier that identifies a path between the root node of the given document to the given target node, in block 805. The cache memory of the semi-structured database server 170 can be a component of element 315 of FIG. 3, the volatile memory 402 and the disk drive 403 of FIG. 4, and so on. The cache memory of the semi-structured database server 170 is generally expected to have faster access times relative to a main memory or bulk memory component of the semi-structured database server 170.

Referring to FIG. 8, in an example, the semi-structured database server 170 may update the value table in the cache memory to include the values of simple nodes from one or more new documents being incorporated into the semi-structured database, in block 810. The operation in block 810 can be considered a type of pre-caching, as the caching in block 810 is triggered by scanning the one or more new documents when they are imported without requiring a series of queries resulting in the same value being returned as in the caching in blocks 800-805. For example, in block 810, the scanning by the semi-structured database server 170 in block 810 may include searching the one or more new documents for nodes that store a single value (e.g., an integer, a date, a small amount of text data such as one or two words of text, etc.), which are categorized by the semi-structured database server 170 as simple nodes. Upon detection of one or more simple nodes during the scanning in block 810, the semi-structured database server 170 may add the value(s) from the one or more detected simple nodes into the cache memory. Accordingly, in an example, the pre-caching in block 810 can occur irrespective of whether any search queries are executed on the pre-cached simple nodes.

Referring to FIG. 8, in an example, the semi-structured database server 170 may prune (or remove) certain cached values from the value table that were initially cached in blocks 805 and/or 810 over time, in block 815. In an example, each cached value in blocks 805 and/or 810 may be cached in association with a time at which the target node associated with the cached value was last queried or, for pre-cached values in block 810, a time when the pre-cached values were added to the cache. If a threshold period of time elapses from the aforementioned times either without any query or with too few queries being directed to an associated target node (i.e., lack of use), the cached value can be removed from the value table. For example, a half-life based decrement can be used, whereby a counter can be incremented by a first value each time a cached value is accessed while being decremented by a second value at a given time interval, whereby the cached value is removed from the cache when the counter drops below a threshold value such that the cache accesses for the cached value need to “keep up” with the time-based decrements in order to remain in the cache. Alternatively, cached values can be removed from the cache memory in response to detection of a low-memory condition. In another example, a combination of low-memory condition detection and frequency of access can be used, whereby the cached values which have not been accessed in the longest period of time are targeted for removal from the cache memory in response to a low-memory detection. The threshold used in block 800 of FIG. 8 for selectively caching the value returned by the simple node need not be the same as the threshold(s) (if any) used in block 815 for pruning the cache memory, although this is possible.

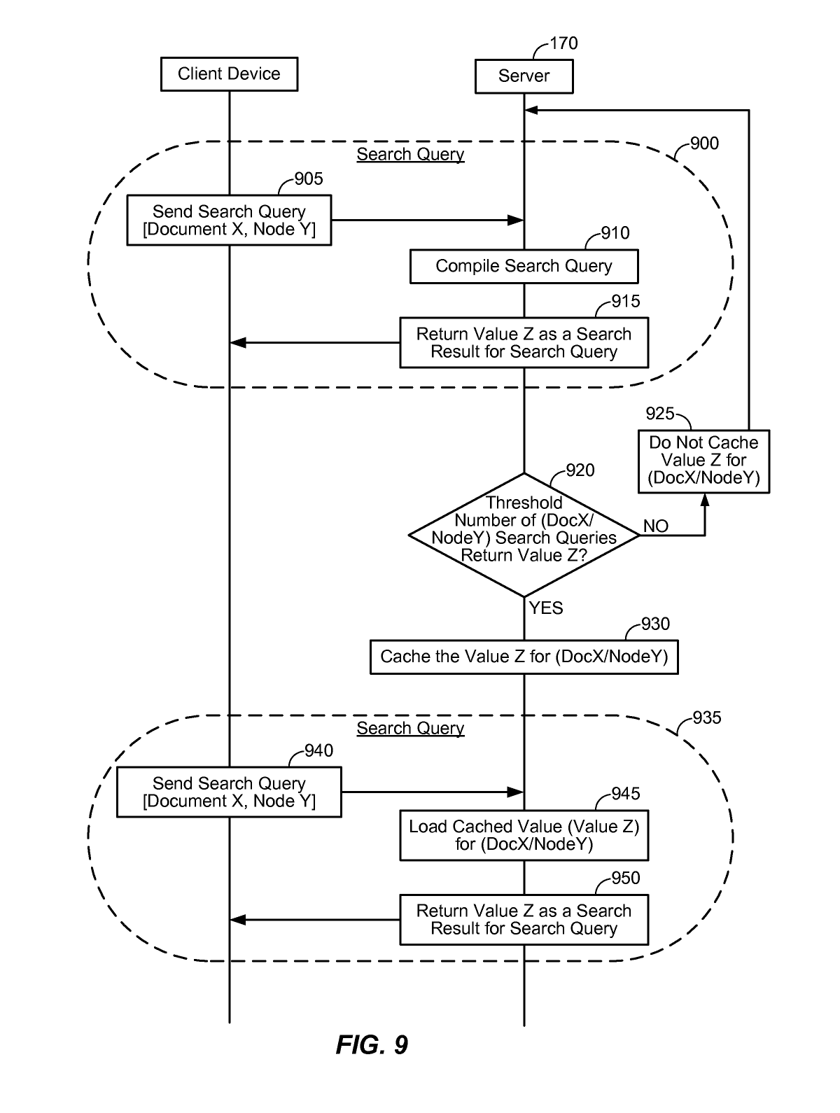

FIG. 9 illustrates an example implementation of the process of FIG. 8 in accordance with an embodiment of the disclosure. Referring to FIG. 9, block sequence 900 depicts execution of a search query, whereby a given client device sends the search query to the semi-structured database server 170, in block 905, the semi-structured database server 170 compiles each search parameter in the search query to obtain search results, in block 910, and the semi-structured database server 170 returns any search results for the search query back to the given client device, in block 915. In an example, compiling the search query in block 910 can include a number of operations, such as joining search results returned for different search parameters. With respect to FIG. 9, the search query in block 900 is directed at least in part to a lookup of Node Y of Document X, with Value Z being returned as a result of this lookup. It will be appreciated that, in an alternative scenario, the lookup of Node Y of Document X may be performed as an intermediate query (e.g., a reference, etc.) that does not result in Value Z being returned directly to the given client device.

At block 920, the semi-structured database server 170 determines whether the previous execution of the search query at block 900 results in a threshold number of search queries being directed to Node Y of Document X returning the Value Z (e.g., similar to 800 of FIG. 8). If the semi-structured database server 170 determines that the search query in block 900 does not result in the threshold number of search queries directed to Node Y of Document X and returning Value Z being reached in block 920, then the Value Z is not cached for Node Y of Document X, in block 925, and the process returns to block 900 for execution of another search query from the same or different client device. Otherwise, if the semi-structured database server 170 determines that the search query of block 900 results in the threshold number of search queries directed to Node Y of Document X and returning Value Z being reached at block 920, then the Value Z is cached for Node Y of Document X in the cache memory of the semi-structured database server 170, in block 930. In an example, each value that is cached for each node can be recorded in a table (“value table”) which is evaluated when subsequent search queries are received, as follows:

TABLE 17
Value Table Example

| (DocID, NodeID) | Value |
|---|---|
| (40, 6) | Brown |
| (40, 14) | December 25 |
| (41, 2) | 1234 |
| (X, Y) | Z |

whereby Node 6 of Document 40 is cached to value “Brown”, Node 14 of Document 40 is cached to value “December 25”, Node 2 of Document 41 is cached to value “1234” and Node Y of Document X (after block 930 of FIG. 9) is cached to value “Z”. In block 930, the combination of Node Y and Document X acts as a key by which Value Z is indexed in the cache memory (e.g., a simple node cache memory that stores values associated with expected simple nodes as detected in block 800 or scanned simple nodes as in block 810).

Referring to FIG. 9, block sequence 935 depicts execution of a new search query, whereby the same or different client device sends the new search query to the semi-structured database server 170, in block 940, after which the semi-structured database server 170 detects that the new search query is directed at least in part to Node Y of Document X. Based on this detection, the semi-structured database server 170 compares Node Y of Document X to its cached value(s) in the value table of the cache memory and determines that Value Z is cached for Node Y of Document X, and thereby loads Value Z, in block 945, and returns Value Z as a search result for the new search query, in block 950. In a more detailed example, in block 945, loading of Value Z from the cache memory may be implemented by the semi-structured database server 170 by comparing the node and document specified in the new search query received in 940 to the keys (or DocID,NodeID combinations) in the cache memory, identifying a matching key, and then loading an associated value from the matching key. While not shown expressly in FIG. 9, a new search query for which no matching key is identified in the cache memory may be compiled similarly to block 910. It will be appreciated that, in an alternative scenario, the lookup of Node Y of Document X may be performed as an intermediate query (e.g., a reference, etc.) that does not result in Value Z being returned directly to the given client device.

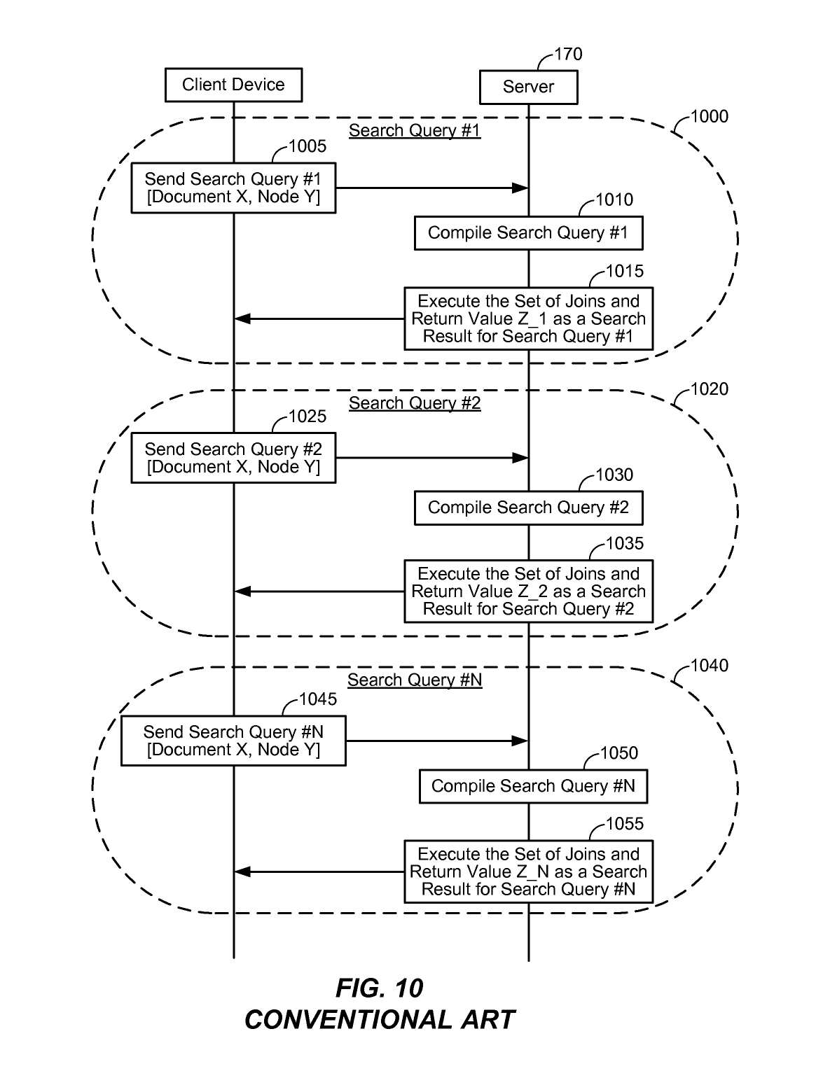

While FIGS. 7-9 relate to the scenario whereby values are cached based on an expectation that a particular set of nodes will consistently return the same value in response to search queries, it is also possible that a node can store different values and/or different types of values and can simply be so popular in terms of search queries that caching becomes beneficial, as will be explained below with respect to FIGS. 10-12.

FIG. 10 illustrates a conventional process by which search queries are executed in a semi-structured database. Referring to FIG. 10, block sequence 1000 depicts execution of a first search query, whereby a given client device sends the first search query to the semi-structured database server 170, in block 1005, the semi-structured database server 170 compiles each search parameter in the first search query to obtain search results, in block 1010, and the semi-structured database server 170 then returns any search results for the first search query back to the given client device, in block 1015. In an example, compiling the search query at block 1010 can include a number of operations, such as joining search results returned for different search parameters. With respect to FIG. 10, the first search query is directed at least in part to a lookup of Node Y of Document X, with Value Z_1 being returned as a result of this lookup. It will be appreciated that, in an alternative scenario, the lookup of Node Y of Document X may be performed as an intermediate query (e.g., a reference, etc.) that does not result in Value Z_1 being returned directly to the given client device.

Referring to FIG. 10, block sequence 1020 depicts execution of a second search query, whereby the same or different client device sends the second search query to the semi-structured database server 170, in block 1025, the semi-structured database server 170 compiles each search parameter in the second search query to obtain search results, in block 1030, and the semi-structured database server 170 then returns any search results for the second search query back to the requesting client device, in block 1035. In an example, compiling the search query at block 1030 can include a number of operations, such as joining search results returned for different search parameters. With respect to FIG. 10, the second search query is also directed at least in part to a lookup of Node Y of Document X, with a different value (i.e., Value Z_2) being returned as a result of this lookup. It will be appreciated that, in an alternative scenario, the lookup of Node Y of Document X may be performed as an intermediate query (e.g., a reference, etc.) that does not result in Value Z_2 being returned directly to the requesting client device.

Referring to FIG. 10, block sequence 1040 depicts execution of an Nth search query, whereby the same or different client device sends the Nth search query to the semi-structured database server 170, in block 1045, the semi-structured database server 170 compiles each search parameter in the Nth search query to obtain search results, in block 1050, and the semi-structured database server 170 then returns any search results for the Nth search query back to the requesting client device, in block 1055. In an example, compiling the search query at block 1050 can include a number of operations, such as joining search results returned for different search parameters. With respect to FIG. 10, the Nth search query is also directed at least in part to a lookup of Node Y of Document X, with another different value (i.e., Value Z_N) being returned as a result of this lookup. It will be appreciated that, in an alternative scenario, the lookup of Node Y of Document X may be performed as an intermediate query (e.g., a reference, etc.) that does not result in Value Z_N being returned directly to the requesting client device.

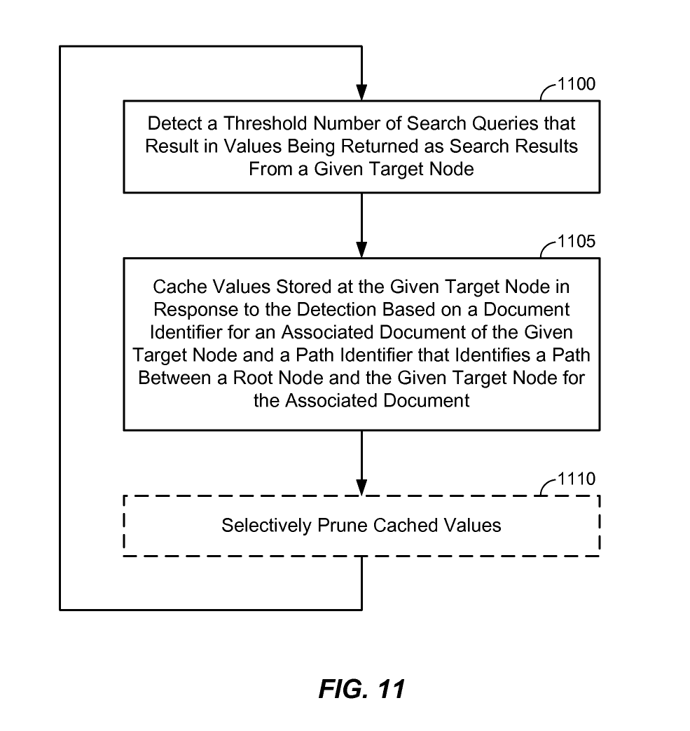

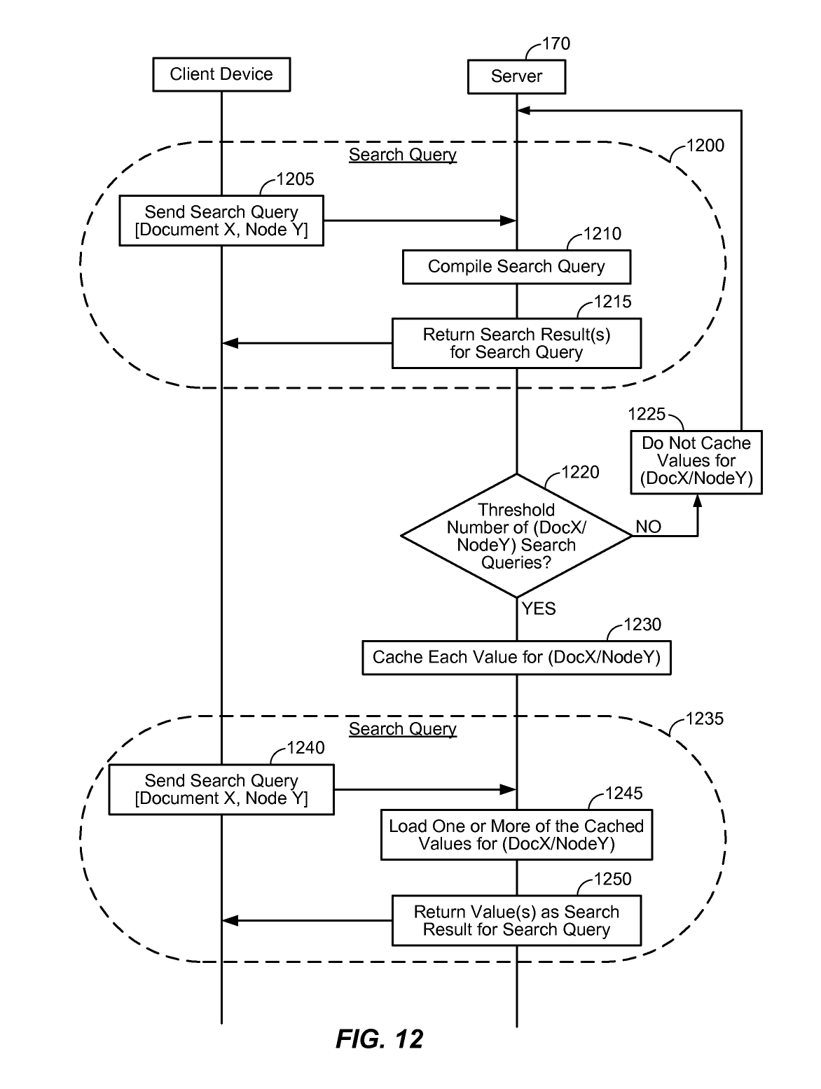

As will be appreciated from a review of FIG. 10, Node Y of Document X is a popular node from a search query perspective, but Node Y of Document X returns different values in response to different search queries, such that Node Y of Document X does not correspond to a simple node as in FIGS. 7-9. Embodiments of the disclosure are thereby directed to selectively caching each value associated with a multi-value popular node, as will be described below with respect to FIGS. 11-12.

FIG. 11 illustrates a process of selectively caching node values in accordance with an embodiment of the disclosure. Referring to FIG. 11, the semi-structured database server 170 detects a threshold number of search queries directed to a given target node of a given document, in block 1100. Unlike FIG. 7, the values returned in association with the threshold number of search queries do not need to be the same, although this is possible. The threshold number can be set by an operator of the semi-structured database based on empirical study in an example. Further, the threshold number used in block 1100 need not be the same as the threshold number used in 800 of FIG. 8. For example, a relatively small number of search queries returning the same value from a particular node may be sufficient to conclude that the node is a simple node such that caching is warranted as in FIG. 8. In at least one example, a higher relative threshold can be used in block 1100 of FIG. 8 because, as will be discussed below in more detail, a resultant caching operation for the associated node may result in more space in the cache memory of the semi-structured database server 170 being occupied for node-based caching (i.e., FIG. 11) as opposed to value-based caching (i.e., FIG. 8).

Further, with respect to block 1100 of FIG. 11, evaluation of the threshold may be based on a node-specific access counter that is maintained by the semi-structured database server 170. In contrast to the node-specific value counter discussed above with respect to 800 of FIG. 8 which is based on an analysis of the values returned by the search queries to a node, the returned values do not necessarily impact the node-specific access counter used by the semi-structured database server 170 in the process of FIG. 11. In other words, the node-specific access counter in FIG. 11 is based on the total number of search queries to a particular node (e.g., in a particular period of time, etc.), whereas the node-specific value counter in FIG. 8 is based on a number of search queries to a particular node that return the same value. In an example, node-specific access counters can be maintained for each node at each document in the semi-structured database, or alternatively can only be maintained for certain nodes in a more selective manner. One example by which the node-specific access counters can be maintained for nodes in a selective manner is by node-type (e.g., XML has different types of nodes, and only certain types of nodes may be allocated node-specific access counters) or by node depth (e.g., nodes less than a threshold depth in a tree hierarchy of a document may be allocated node-specific access counters, while nodes equal to or greater than the threshold depth are not allocated node-specific access counters).

Referring to FIG. 11, in response to the detection in block 1100, the semi-structured database server 170 caches, in the cache memory of the semi-structured database server 170, values stored at the given target node in association with (or based on) a document identifier for the given document and a path identifier that identifies a path between the root node of the given document and the given target node, in block 1105. As noted above with respect to 805, the cache memory of the semi-structured database server 170 can be a component of the logic configured to store information 315 of FIG. 3, elements 402-403 of FIG. 4, and so on. The cache memory of the semi-structured database server 170 is generally expected to have faster access times relative to a main memory or bulk memory component of the semi-structured database server 170.

Referring to FIG. 11, in an example, the semi-structured database server 170 may prune (or remove) certain cached values that were initially cached at block 1105 over time, in block 1110. In an example, each cached value from block 1105 may be cached in association with a time at which the target node associated with the cached value was last queried. If a threshold period of time elapses from the aforementioned times either without any query or with too few queries being directed to an associated target node, the cached value(s) for the associated node can be removed from the cache. In a further example, the threshold period of time can be implemented as a half-life function whereby the node-specific access counter for a particular node is decremented at a given time interval. Alternatively, cached values can be removed from the cache memory in response to detection of a low-memory condition. In another example, a combination of low-memory condition detection and frequency of access can be used, whereby the cached values which have not been accessed in the longest period of time are targeted for removal from the cache memory in response to a low-memory detection. In an example, cache value pruning in block 1110 can be implemented on a node-basis, such that each cached value associated with a particular node is removed if pruning is determined for the particular node.

FIG. 12 illustrates an example implementation of the process of FIG. 11 in accordance with an embodiment of the disclosure. Referring to FIG. 12, block sequence 1200 depicts execution of a search query, whereby a given client device sends the search query to the semi-structured database server 170, in block 1205, the semi-structured database server 170 compiles each search parameter in the search query to obtain search results, in block 1210, and the semi-structured database server 170 then returns any search results for the search query back to the given client device, in block 1215. In an example, compiling the search query at block 1210 can include a number of operations, such as joining search results returned for different search parameters. With respect to FIG. 12, the search query at block 1200 is directed at least in part to a lookup of Node Y of Document X, whereby the result of the lookup of Node Y of Document X can be returned directly to the requesting client device or else can be re-used to initiate an intermediate query (e.g., a reference, etc.) for satisfying the search query in block 1200.

At block 1220, the semi-structured database server 170 determines whether the previous execution of the search query at block 1200 results in a threshold number of search queries being directed to Node Y of Document X (e.g., similar to block 1100 of FIG. 11). If the semi-structured database server 170 determines that the search query in block 1200 does not result in the threshold number of search queries directed to Node Y of Document X in block 1220, then the values at Node Y of Document X are not cached, in block 1225, and the process returns to block 1200 for execution of another search query from the same or different client device. Otherwise, if the semi-structured database server 170 determines that the search query in block 1200 results in the threshold number of search queries directed to Node Y of Document X being reached at block 1220, then two or more values are cached for Node Y of Document X in the value table maintained in the cache memory of the semi-structured database server 170, in block 1230. In an example, the caching operation of block 1230 caches all values stored at Node Y of Document X in the value table of the cache memory, although this is not expressly necessary in all embodiments (e.g., certain values that are never accessed or only infrequently accessed need not be cached, etc.). In an example, each value that is cached for each node can be recorded in the value table which is evaluated when subsequent search queries are received, as follows:

TABLE 18
Value Table Example

| (DocID, NodeID) | Value |
|---|---|
| (40, 6) | Brown |
| (40, 6) | Smith |
| (40, 6) | Johnson |
| (40, 6) | Chang |
| (40, 6) | Morrison |
| (X, Y) | Z_1 |
| (X, Y) | Z_2 |
| (X, Y) | Z_3 |
| (X, Y) | Z_4 |
| (X, Y) | Z_5 |

whereby Node 6 of Document 40 is a “Last Name” node that includes cached values for “Brown”, “Smith”, “Johnson”, “Chang”, and “Morrison”, and Node Y of Document X includes cached values for Z_1 through Z_5 (after block 1230).

Referring to FIG. 12, block sequence 1235 depicts execution of a new search query, whereby the same or different client device sends the new search query to the semi-structured database server 170, in block 1240, after which the semi-structured database server 170 detects that the new search query is directed at least in part to Node Y of Document X. Based on this detection, the semi-structured database server 170 compares Node Y of Document X to its cached value(s) in the value table of the cache memory and determines that Values Z_1 through Z_5 are cached for Node Y of Document X, and thereby one or more of Node Y's cached value, in block 1245, and returns loaded cached value(s) as a search result for the new search query, in block 1250. It will be appreciated that, in an alternative scenario, the lookup of Node Y of Document X may be performed as an intermediate query (e.g., a reference, etc.) that does not result in the loaded cached value(s) being returned directly to the given client device.

Search queries can be bundled together for execution in a particular order, which is collectively referred to as a merge query. For example, if a merge query: //a[@b=″c″]/d/e results in 10 context entries for the @b=″c″ node, then the merge query would be performed as:

TABLE 19
Example of Merge Query

descendant(contains(a, merge(a/@b(1)=“c”, a/@b(2)=“c”,
a/@b(3)=“c”, a/@b(4)=“c”, a/@b(5)=“c”, a/@b(6)=“c”,
a/@b(7)=“c”, a/@b(8)=“c”, a/@b(9)=“c”, a/@b(10)=“c”)), a/d/e)

which can be rewritten as follows:

TABLE 20
Example of Merge Query

merge(
descendant(contains(a, a/@b(1)=“c”), a/d/e)
descendant(contains(a, a/@b(2)=“c”), a/d/e)
descendant(contains(a, a/@b(3)=“c”), a/d/e)
descendant(contains(a, a/@b(4)=“c”), a/d/e)
descendant(contains(a, a/@b(5)=“c”), a/d/e)
descendant(contains(a, a/@b(6)=“c”), a/d/e)
descendant(contains(a, a/@b(7)=“c”), a/d/e)
descendant(contains(a, a/@b(8)=“c”), a/d/e)
descendant(contains(a, a/@b(9)=“c”), a/d/e)
descendant(contains(a, a/@b(10)=“c”), a/d/e)
)

whereby each “descendant” operation occurs in-order from top to bottom. The “descendant” function depicted in Tables 19-20 represents alternative terminology for referring to a search query. As will be appreciated, the “descendant” and “contains” functions require joins. However, the “merge” function itself is a simple concatenation (or aggregation) of results. Accordingly, the original //a[criteria]/d/e can be solved in two different ways, (Table 19) by joining (“descendant(contains( )”) a concatenated (“merge”) list of results with “a/d/e”; or (Table 20) by concatenating the results from multiple smaller joins. Using the Table 19 execution allows us to reorder the smaller joins to compute the joins that will more likely return data. Accordingly, Tables 19-20 depict two different ways of executing the same search using either one large join (Table 19) or multiple smaller joins (Table 20).

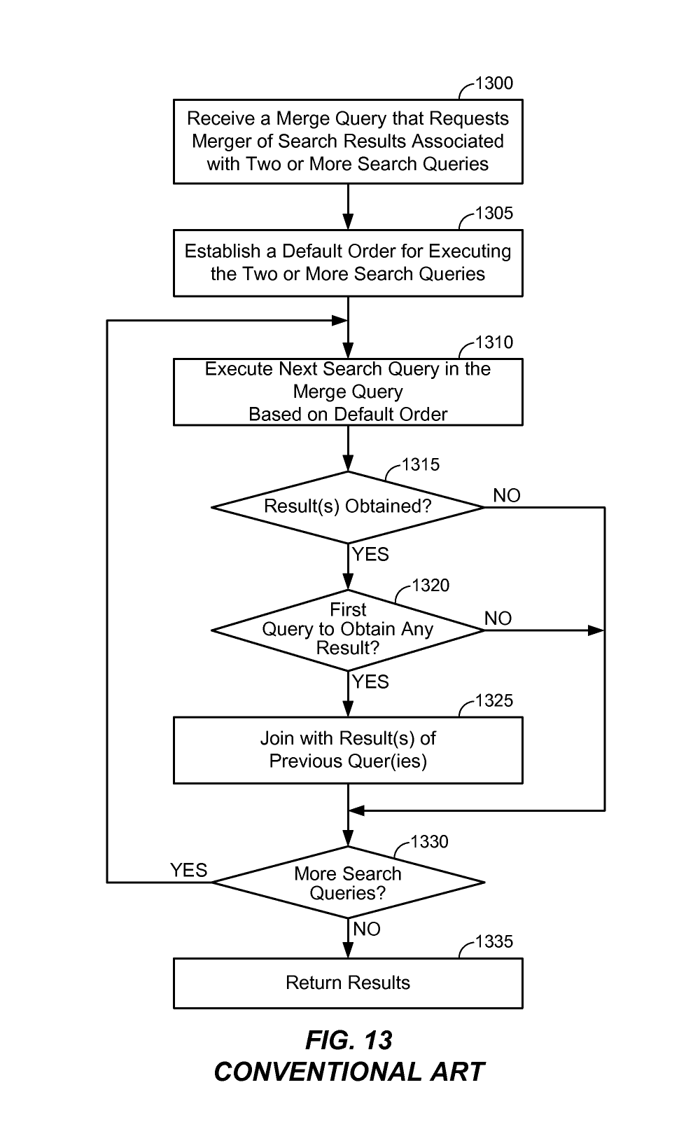

FIG. 13 illustrates a conventional merge query execution in a semi-structured database. Referring to FIG. 13, the semi-structured database server 170 receives a merge query that requests a merger of search results associated with two or more search queries (e.g., such as the descendants depicted in Table 20, above), in block 1300. The semi-structured database server 170 establishes a default order for executing the two or more search queries, in block 1305. When the merge query does not specify the order in which the two are more search queries are to be performed, the semi-structured database server 170 may conventionally determine the default order in an arbitrary manner, such as the order in which the respective search queries were listed in the merge query command received at block 1300. At block 1310, the semi-structured database server 170 executes the next search query in the merge query in the default order (in this case, the first search query, which in Table 20 is “descendant(contains(a, a/@b(1)=“c”), a/d/e)”). At block 1315, the semi-structured database server 170 determines if any results were obtained by the search query execution from block 1310. If not, the process advances to block 1330. Otherwise, if at least one result is determined to be obtained from the search query execution at block 1315, the semi-structured database server 170 determines whether the search query execution from block 1310 is the first search query in the merge query to obtain any results, in block 1320.

If the semi-structured database server 170 determines that the search query execution from block 1310 is the first search query in the merge query to obtain any results at block 1320, the process advances to block 1330. Otherwise, if the semi-structured database server 170 determines the search query execution from block 1310 is not the first search query in the merge query to obtain any results at block 1320, then the semi-structured database server 170 joins the search results obtained at block 1310 for the current search query execution with the search results obtained for earlier search query executions, in block 1325. In an example, a single join may be performed in block 1325 irrespective of how many preceding search queries in the merge query have obtained result(s) (e.g., starting with the third search query in the merge query based on the default order that returns result(s), the result(s) obtained in block 1315 for a new search query may be joined with previous join result(s) obtained in 1325). At block 1330, the semi-structured database server 170 determines whether the current search query is the last search query in the default order for the merge query. If the current search query is not determined to be the last search query in the default order for the merge query at block 1330, the process returns to block 1310 and the next search query in the default order is executed and then evaluated. Otherwise, the current set of search results (which are joined from each search query that produced any results) is returned to the client device that requested the merge query, in block 1335.

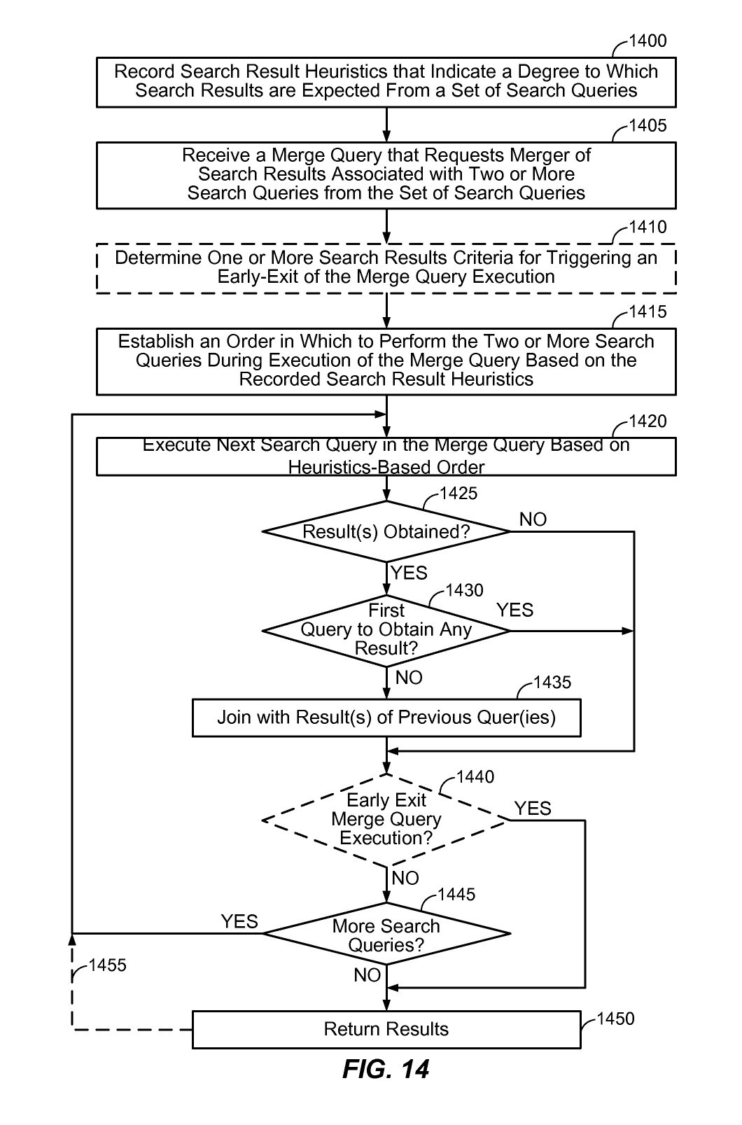

For some merge queries, a user may only need a limited number of search results and/or may prioritize quickly-returned partial search results over a more complete (but slower) set of search results. The queries that collectively constitute the merge query can intermingle search queries that produce high numbers of search results with search queries that produce few or even zero search results. Accordingly, performing each search query in an exhaustive manner as in FIG. 13 can potentially introduce search delays without necessarily improving the quality of the returned search results from a user perspective. Embodiments of the disclosure are thereby directed to dynamically establishing an order in which the individual queries of a merge query are executed based on search result heuristics, as will be described below with respect to FIG. 14.

FIG. 14 illustrates a process of executing a merge query in accordance with an embodiment of the disclosure. Referring to FIG. 14, the semi-structured database server 170 records search result heuristics in a search query heuristics table over time that indicate a degree to which search results are expected from a set of search queries, in block 1400. For example, each time a search query is executed by the semi-structured database server 170, the semi-structured database server 170 can generate and/or update the search result heuristics table maintained in memory at the semi-structured database server 170 based on the number of search results obtained from the search query. The search result heuristics table can be configured in a variety of ways. For example, each entry of the search result heuristics table may indicate (i) a number of search results obtained by a most recent execution of the associated search query, (ii) an average number of search results obtained by the search query over time based on multiple executions of the search query, (iii) or any combination thereof

TABLE 21
Search Result Heuristics Table Example

| Search Query | Search Query Heuristics |
|---|---|
| descendant(contains(a, a/@b(1)=“c”), a/d/e) | AVERAGE(44,3) |
| descendant(contains(a, a/@b(2)=“c”), a/d/e) | PREVIOUS(52) |
| descendant(contains(a, a/@b(3)=“c”), a/d/e) | PREVIOUS(0) |
| descendant(contains(a, a/@b(4)=“c”), a/d/e) | AVERAGE (0,7) |
| descendant(contains(a, a/@b(5)=“c”), a/d/e) | N/A |
| descendant(contains(a, a/@b(6)=“c”), a/d/e) | N/A |
| descendant(contains(a, a/@b(7)=“c”), a/d/e) | AVERAGE (43,77) |
| descendant(contains(a, a/@b(8)=“c”), a/d/e) | N/A |
| descendant(contains(a, a/@b(9)=“c”), a/d/e) | PREVIOUS(1) |
| descendant(contains(a, a/@b(10)=“c”), a/d/e) | AVERAGE(300,2) |

whereby AVERAGE(44,3) indicates that three previous search queries directed to descendant(contains(a, a/@b(1)=“c”), a/d/e) returned an average of 44 search results, PREVIOUS(52) indicates that the previous search query for descendant(contains(a, a/@b(2)=“c”), a/d/e) returned 52 search results, PREVIOUS(0) indicates that the previous search query for descendant(contains(a, a/@b(3)=“c”), a/d/e) returned 0 search results, AVERAGE(0,7) indicates that the previous seven search queries for descendant(contains(a, a/@b(4)=“c”), a/d/e) each returned 0 search results, N/A indicates that the search result heuristics table does not record any information for the corresponding search query, and so on. It will be appreciated that the search result heuristics table could be simplified (e.g., only include the AVERAGE statistics, only include the PREVIOUS statistics, etc.) or enhanced (e.g., add in statistics such as standard deviation, etc.).

Referring to FIG. 14, the semi-structured database server 170 receives a merge query that requests merger of search results associated with two or more search queries (e.g., such as the descendants depicted in Table 20, above), in block 1405. In an example, the semi-structured database server 170 may also determine, in association with the merge query, one or more search results criteria for triggering an early-exit of the merge query execution, in block 1410. For example, the one or more search results criteria for triggering an early-exit of the merge query execution can include a threshold number of search results for a union merge query (e.g., stop additional processing of merge query and return current results when current results exceed the threshold number of search results) or an intersection merge query (e.g., stop additional processing of merge query and return current results when current results fall below the threshold number of search results), a time limit (e.g., stop additional processing of merge query and return current results when the time limit is up irrespective of current number of search results) or any combination thereof. If the operation of block 1410 is performed, the semi-structured database server 170 will monitor the one or more search results criteria during execution of the respective search queries of the merge query in order to determine whether to exit the merge query execution before all respective search queries complete their execution, as discussed below with respect to block 1440.

Referring to FIG. 14, instead of establishing a default or arbitrary order for executing the respective search queries of the merge query, the semi-structured database server 170 establishes an order in which to execute the two or more search queries based on the recorded search result heuristics from the search result heuristics table of block 1400, in block 1415. The heuristics-based order can be established in a number of different ways based upon the parameters of the merge query. For example, if the merge query is a union search query (e.g., each unique search result from each query is returned to requesting client device), the heuristics-based order may select the search queries expected to return the highest number of search results first in the order, with search queries expected to return the lowest number of search results moved to the end of the order. This will typically result in the merge query reaching a higher number of search results more quickly. In another example, if the merge query is an intersection search query (e.g., only search results that are returned for each search query are returned to the requesting client device), the heuristics-based order may select the search queries expected to return the lowest number of search results first in the order, with search queries expected to return the highest number of search results moved to the end of the order. This will typically result in the intersection being converged upon more quickly.

Using the search heuristics table depicted in Table 21 as an example, the heuristics-based order may be established as follows at block 1415:

TABLE 22
Example of Heuristics-Based Search Order for Union Merge Query
[Highest to Lowest]

| | |
|---|---|
| merge( | |
| descendant(contains(a, a/@b(10)=“c”), a/d/e) | [AVERAGE(300,2)] |
| descendant(contains(a, a/@b(7)=“c”), a/d/e) | [AVERAGE (43,77)] |
| descendant(contains(a, a/@b(1)=“c”), a/d/e) | [AVERAGE(44,3)] |
| descendant(contains(a, a/@b(4)=“c”), a/d/e) | [PREVIOUS(52)] |
| descendant(contains(a, a/@b(9)=“c”), a/d/e) | PREVIOUS(1) |
| descendant(contains(a, a/@b(5)=“c”), a/d/e) | N/A |
| descendant(contains(a, a/@b(6)=“c”), a/d/e) | N/A |
| descendant(contains(a, a/@b(8)=“c”), a/d/e) | N/A |
| descendant(contains(a, a/@b(3)=“c”), a/d/e) | [PREVIOUS(0)] |

descendant(contains(a, a/@b(4)=“c”), a/d/e) [AVERAGE (0,7)]
)

whereby an order establishing protocol weights the search query rankings by a combination of prior search results achieved (higher numbers preferred) and reliability (e.g., AVERAGE(300,2) expected to return high search results despite a low sample size of 2, while AVERAGE(43,77) provides similar search results as compared to AVERAGE(44,3) but has a higher sample size and is deemed more reliable, the N/As are ranked below any search query except for search queries expected to return zero search results, and so on), whereby the aforementioned order is reversed for intersection merge queries, as follows:

TABLE 23
Example of Heuristics-Based Search Order for Intersection Merge Query
[Lowest to Highest]

| | |
|---|---|
| merge( | |
| descendant(contains(a, a/@b(4)=“c”), a/d/e) | [AVERAGE (0,7)] |
| descendant(contains(a, a/@b(3)=“c”), a/d/e) | [PREVIOUS(0)] |
| descendant(contains(a, a/@b(8)=“c”), a/d/e) | N/A |
| descendant(contains(a, a/@b(6)=“c”), a/d/e) | N/A |
| descendant(contains(a, a/@b(5)=“c”), a/d/e) | N/A |
| descendant(contains(a, a/@b(9)=“c”), a/d/e) | PREVIOUS(1) |
| descendant(contains(a, a/@b(4)=“c”), a/d/e) | [PREVIOUS(52)] |
| descendant(contains(a, a/@b(1)=“c”), a/d/e) | [AVERAGE(44,3)] |
| descendant(contains(a, a/@b(7)=“c”), a/d/e) | [AVERAGE (43,77)] |
| descendant(contains(a, a/@b(10)=“c”), a/d/e) | [AVERAGE(300,2)] |
| ) | |

whereby an order establishing protocol weights the search query rankings by a combination of prior search results achieved (higher numbers preferred) and reliability in a manner that is the opposite depicted in Table 22 due to the differing objective of the intersection merge query relative to the union merge query.

At block 1420, the semi-structured database server 170 executes the next search query in the merge query in the heuristics-based order (in this case, the first search query, such as the top-listed search query in Table 22 or Table 23). At block 1425, the semi-structured database server 170 determines if any results were obtained by the search query execution from 1420. If not, the process advances to block 1440. Otherwise, if at least one result is determined to be obtained from the search query execution at block 1420, the semi-structured database server 170 determines whether the search query execution from block 1420 is the first search query in the merge query to obtain any results, in block 1430.

If the semi-structured database server 170 determines that the search query execution from block 1420 is the first search query in the merge query to obtain any results at block 1430, the process advances to block 1440. Otherwise, if the semi-structured database server 170 determines the search query execution from block 1420 is not the first search query in the merge query to obtain any results at block 1430, then the semi-structured database server 170 joins (e.g., via union or intersection depending on the nature of the merge query) the search results obtained at block 1420 for the current search query execution with the search results obtained for earlier search query executions, in block 1435. In an example, a single join may be performed in block 1435 irrespective of how many preceding search queries in the merge query have obtained result(s) (e.g., starting with the third search query in the merge query based on the default order that returns result(s), the result(s) obtained in block 1425 for a new search query may be joined with previous join result(s) obtained in 1435). At block 1440, in an example, the semi-structured database server 170 may determine whether any of the one or more search results criteria for triggering an early-exit of the merge query execution have been satisfied. If so, then the current search results (if any) are returned to the requesting client device, in block 1450. Otherwise, the semi-structured database server 170 determines whether the current search query is the last search query in the heuristics-based order for the merge query, in block 1445. If the current search query is not determined to be the last search query in the heuristics-based order for the merge query at block 1445, the process returns to block 1420 and the next search query in the heuristics-based order is executed and then evaluated. Otherwise, the current set of search results (which are joined from each search query that produced any results) is returned to the client device that requested the merge query, in block 1450.

As noted above, when an early-exit of the merge query execution is determined in block 1440, the current search results can be returned to the requesting client device in block 1450. At this point, in an example, the semi-structured database server 170 may stop executing the merge query altogether in order to save resources, in which case no further search results for the merge query will be returned to the requesting client device. In another example, in block 1455, the semi-structured database server 170 may continue executing the merge query after the early-exit search results are returned in block 1450. In block 1455, the process returns to block 1420 and the next search query in the heuristics-based order is executed and then evaluated. In this alternative example, the search results returned to the requesting client device in block 1450 may be refined over time as search results for new search queries in the merge query are obtained in block 1425 and joined with the search result(s) from previous search queries in block 1435. In a further example, the process by which more refined search results are returned to the requesting client device in block 1450 as more search queries in the merge query are executed may continue until the last search query in the heuristics-based order for the merge query is processed and/or until the one or more search results criteria for triggering an early-exit of the merge query execution are no longer satisfied in block 1440.

As noted above, the merge query described with respect to FIG. 14 may correspond to a union merge query or an intersection merge query. Further, the merge query described with respect to FIG. 14 may include one or more “nested” merge queries (e.g., union and/or intersection), whereby the result(s) of the one or more nested merge queries obtained and then merged as part of the execution of the higher-level merge query. Accordingly, merge queries do not necessarily consist merely of search queries, but can include one or more union merge queries, one or more intersection queries, one or more search queries or any combination thereof. In an example, a nested merge query may be executed independently, with any search result(s) from the nested merge query being returned to the higher-level merge query for joining (e.g., in which case, the process depicted in FIG. 14 may execute separately for each nested merge query and then the higher-level merge query). In another example, a query engine at the semi-structured database server 170 may un-nest any nested merge queries into a sequence of joins (e.g., at which point, the higher-level merge query may be executed via a single execution of the process of FIG. 14). As used herein, reference to a search query that is included in a merge query may refer to the scenario where the search query is listed as part of the merge query directly or alternatively to the scenario where the merge query includes a nested merge query that lists the search query.

While the processes are described as being performed by the semi-structured database server 170, as noted above, the semi-structured database server 170 can be implemented as a client device, a network server, an application that is embedded on a client device and/or network server, and so on. Hence, the apparatus that executes the processes in various example embodiments is intended to be interpreted broadly.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
detecting a threshold number of search queries for which a given value at a given target node for a given document of the set of documents is returned as a search result; and
caching, in a value table stored in a cache memory, the given value in response to the detecting based on a document identifier for the given document and a path identifier that identifies a path between the root node and the given target node.

2. The method of claim 1, further comprising:
obtaining a new document to import among the set of documents of the semi-structured database;
scanning the new document to detect one or more simple nodes that are configured to return a single value; and
pre-caching the one or more detected simple nodes in the cache memory based on the scanning.

3. The method of claim 2, wherein the scanning is performed irrespective of whether any search queries are executed on the one or more simple nodes.

4. The method of claim 1, further comprising:
selectively pruning at least one value from the value table based on lack of use, a low-memory condition of the cache memory or any combination thereof.

5. The method of claim 1, further comprising:
receiving a new search query directed to the given target node for the given document;
loading the given value from the value table in the cache memory; and
returning the loaded value as a search result for the new search query.

6. The method of claim 1,
wherein the semi-structured database is an Extensible Markup Language (XML) database, or
wherein the semi-structured database is a JavaScript Object Notation (JSON) database.

7. The method of claim 1, wherein the plurality of nodes are logical nodes deployed at one or more physical devices.

8. The method of claim 1,
wherein the set of documents includes a single document, or
wherein the set of documents includes multiple documents.

9. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
detecting a threshold number of search queries that result in values being returned as search results from a given target node for a given document of the set of documents; and
caching, in a value table stored in a cache memory, values stored at the given target node in response to the detecting based on a document identifier for the given document of the given target node and a path identifier that identifies a path between the root node and the given target node for the given document.

10. The method of claim 9, wherein the caching caches each value stored at the given target node.

11. The method of claim 9, further comprising:
selectively pruning at least one value from the value table based on lack of use, a low-memory condition of the cache memory or any combination thereof.

12. The method of claim 11, where the selectively pruning prunes each value associated with a particular node from the value table.

13. The method of claim 9, further comprising:
receiving a new search query directed to the given target node for the given document;
loading a given value from the value table in response to the new search query;
returning the loaded value as a search result for the new search query.

14. The method of claim 9,
wherein the semi-structured database is an Extensible Markup Language (XML) database, or
wherein the semi-structured database is a JavaScript Object Notation (JSON) database.

15. The method of claim 9, wherein the plurality of nodes are logical nodes deployed at one or more physical devices.

16. The method of claim 9,
wherein the set of documents includes a single document, or
wherein the set of documents includes multiple documents.

17. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
recording search result heuristics that indicate a degree to which search results are expected from each search query in a set of search queries;
receiving a merge query that requests a merger of search results including two or more search queries from the set of search queries;
establishing an order in which to perform the two or more search queries during execution of the merge query based on the recorded search result heuristics;
executing at least one of the two or more search queries in accordance with the established order; and
returning one or more merged search results based on the executing.

18. The method of claim 17, further comprising:
determining one or more search results criteria for triggering an early-exit for the executing; and
monitoring the one or more search results criteria during the exiting to determine whether to exit the executing before all of the two or more search queries complete execution.

19. The method of claim 18,
wherein the monitoring detects that the one or more search results criteria are satisfied, and
wherein the executing is exited and the returning returns a current set of search results in response to the monitoring detecting that the one or more search results criteria are satisfied.

20. The method of claim 19, further comprising:
continuing the executing after the returning returns the current set of search results, or
stopping the executing after the returning returns the current set of search results.

21. The method of claim 17,
wherein the merge query is a union merge query, and
wherein the established order is in order of highest to lowest in terms of a search result number expected from the two or more search queries.

22. The method of claim 17,
wherein the merge query is an intersection merge query, and
wherein the established order is in order of lowest to highest in terms of a search result number expected from the two or more search queries.

23. The method of claim 17,
wherein the merge query includes at least one nested merge query, or
wherein the merge query is a nested merge query of a higher-level merge query, or
any combination thereof.

24. A server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
logic configured to detect a threshold number of search queries for which a given value at a given target node for a given document of the set of documents is returned as a search result; and
logic configured to cache, in a value table stored in a cache memory, the given value in response to the detection based on a document identifier for the given document and a path identifier that identifies a path between the root node and the given target node.

25. The server of claim 24, further comprising:
logic configured to obtain a new document to import among the set of documents of the semi-structured database;
logic configured to scan the new document to detect one or more simple nodes that are configured to return a single value; and
logic configured to pre-cache the one or more detected simple nodes in the cache memory based on the scanning.

26. The server of claim 25, wherein the logic configured to scan scans the new document irrespective of whether any search queries are executed on the one or more simple nodes.

27. The server of claim 24, further comprising:
logic configured to selectively prune at least one value from the value table based on lack of use, a low-memory condition of the cache memory or any combination thereof.

28. The server of claim 24, further comprising:
logic configured to receive a new search query directed to the given target node for the given document;
logic configured to load the given value from the value table in the cache memory; and
logic configured to return the loaded value as a search result for the new search query.

29. The server of claim 24,
wherein the semi-structured database is an Extensible Markup Language (XML) database, or
wherein the semi-structured database is a JavaScript Object Notation (JSON) database.

30. The server of claim 24, wherein the plurality of nodes are logical nodes deployed at one or more physical devices.
